(19) United States
(12) Patent Application Publication
(10) Pub. No.: US 2019/0096439 A1
(43) Pub. Date: Mar. 28, 2019

(54) Video tagging and annotation

(71) Applicants: Robert Brouwer, Kusnacht (CH); Ahmed Abdulwahab, Berlin (DE)

(72) Inventors: Robert Brouwer, Kusnacht (CH); Ahmed Abdulwahab, Berlin (DE)

(21) Appl. No.: 16/304,272

(22) PCT Filed: May 23, 2017
(86) PCT No.: PCT/IB2017/053039

§ 371 Date: Nov. 23, 2018

Related U.S. Application Data
(60) Provisional application No. 62/340,440, filed on May 23, 2016.

(51) Int. Cl. G11B 27/036; G06K 9/00

(52) U.S. Cl. CPC G11B 27/036; G06F 3/0484; G06K 9/00711

(57) ABSTRACT

Methods, processes and systems for contextually augmenting and annotating moving pictures or images with tags using region tracking on computing devices with screen displays, including mobile devices and virtual reality headsets. The present invention enables both content authors and viewers to directly tag and link supplementary content to locations representative of objects in a moving picture or image and share these tags with other authorized users.

### CROSS REFERENCE TO RELATED APPLICATIONS

The present application claims the benefit of co-pending U.S. provisional application No. 62/340,440, filed on May 23, 2016, the entire disclosure of which is incorporated by reference as if set forth in its entirety herein.

### TECHNICAL FIELD

This disclosure relates to systems and methods for annotating video, and in particular to systems and methods for associating user-added content with particular portions of a video that may reflect the presence of an object in various frames of the video.

### BACKGROUND

Mobile computing devices with built-in cameras have made recording, uploading and sharing videos easy. As a result, video streaming platforms, such as YouTube and Facebook, have become popular for sharing videos. Powerful video editing software makes creating and producing movies simple. While streaming platforms have evolved over time, so have screen resolutions and video codecs. However, these platforms still do not have the interactive capabilities that some websites have. The main reason for this is that streaming video in its current form is not particularly well suited for interactive consumption by viewers.

Although there are some video sites, such as YouTube, that offer annotations to videos, the ability to add a multitude of titles, notes, spotlights, speech bubbles, etc., to connect and engage an audience are limited. The problem is that these annotations in their current form obscure the user's view of the underlying video content. They are a distraction in particular when multiple annotations are used in the same video sequence or frame. The more graphical elements a video frame contains, the more likely it is that those elements will disrupt the viewing experience.

Another problem is that when clicking on currently existing annotations in a video, they will, depending on the type of content, link for example to other movies or websites and open for each a separate window. The more annotations that are opened, the more windows that need to be opened and as a result the users may sooner or later be overloaded with content.

In addition, these annotations are unidirectional. Users have to manually return to the original video after exploring an annotation. This is not particularly user friendly and consequently a user might therefore consider not clicking any of the annotations. For this reason, annotations in their current form are unlikely to motivate users to interact with these annotations.

From the publisher's perspective annotations should increase stickiness and guide users to other videos from the same publisher or author but instead users are offered a new selection of videos, mostly presented and based on user interest and not on publisher preference. Such is for example with YouTube, unless the video is hosted the publisher's own website.

Moreover, the current form of annotations can only be added by the content author or publisher. Other users typically cannot add annotations to another user's videos. In addition, annotations cannot be easily and directly shared with other users.

In addition, it is often not possible to share an annotation of a particular frame in a video. Instead, users share a specific location in a video by sharing a hyperlink with a code at its end indicating the location in the video.

In closing, the level of interactivity within a video is currently very limited. Annotations should make videos more interactive but unfortunately this is not the case.

### SUMMARY

The present invention describes a method, process and system for contextually augmenting and annotating moving pictures or images with tags using region tracking on computing devices with screen displays, including mobile devices and virtual reality headsets. The present invention enables both content authors and viewers to directly tag and link supplementary content to locations representative of objects in a moving picture or image and share these tags with other authorized users.

In the present invention objects, whether static or in motion, that are identified by the user in a moving picture can be tagged using object tracking technology. Normally object tracking follows or tracks a specific known or pre-identified target or object, whether static or in motion, until it becomes untrackable using techniques such as comparing frames, color tracking, markerless tracking and slam-tracking, to name a few. However, in the present invention the object tracking technology is applied differently. In the present invention “object tracking” refers to the detection and tracking through multiple video frames of a region of pixels that may be representative of an object that the user has selected for annotation or tagging purposes.

There are certain applications, such as education, marketing, product or service support, where highly interactive annotated content is more desirable because it offers users additional information. Embodiments of this invention enable supportive supplementary content and information to be placed in the correct context of an underlying video using tags. As a result the video becomes interactive because a user may, besides viewing the video, also explore and discover the annotated content that users added. Users experience therefore a highly interactive environment that is far more engaging than a traditional movie without any annotations or tags.

The more interactive annotations and content that are added in accord with the present invention, the higher the value of the video content becomes over time. Moreover, the tags provide valuable clues for advertisers. Because tags offer far more granular data, advertising can be better monetized through more effective ad placements. The annotated or tagged content will become far more sticky and useful for advertising because the tags and their location provide valuable data and clues about the level of user interaction with a movie.

With the current invention, content authors can discover any unclear areas and exchange or add additional content in the appropriate context where it is most relevant in order to improve the value of the content. While adding additional content to a video currently requires extensive re-editing or a new version, the present invention allows an author to augment the content with different annotations that are relevant in the right context. As content grows and the interaction increases, the system offers new ways to measure the level of interaction within the video content and help identify areas where content needs to be augmented.

In one aspect, embodiments of the invention relate to a method for annotating videos. The method includes receiving a selection of a location in a starting video frame from a user; identifying a first group of pixels in proximity to the selected location; determining whether the first group of pixels can be tracked through subsequent video frames for a predetermined period of time; and permitting the user to attach a tag to the selected location if the first group of pixels can be tracked for the predetermined period of time.

In one embodiment, the method further includes playing the video while displaying the tag attached to the first group of pixels beginning at the starting video frame and finishing after the predetermined period of time.

In one embodiment, the method further includes associating content with the tag.

In one embodiment, the method further includes displaying the associated content upon interaction with the displayed tag.

In one embodiment, the predetermined period of time is approximately four seconds.

In one embodiment, the method further includes disabling the display of the tag during subsequent plays of the video.

In one embodiment, the attached tag is stored in a transparent overlay separate from the video.

In one embodiment, information concerning the attached tag is stored in a database.

In one embodiment, the method further includes selecting a second, larger, group of pixels in proximity to the selected location when the first group of pixels cannot be tracked for the predetermined period of time. In one embodiment, the method further includes determining whether the second group of pixels can be tracked through subsequent video frames for a predetermined period of time. In one embodiment, the predetermined period of time is four seconds.

In another aspect, embodiments of the present invention relate to a system for annotating video. The system includes a source of video content; and a database of tags, each tag being associated with an element in a video content for a predetermined period of time.

In one embodiment, the system further includes a player to display video content from the source of video content and at least one tag from the database of tags in proximity to the element in the video with which it is associated.

In one embodiment, the player displays the at least one tag in a transparent layer overlaid on the displayed video content.

In one embodiment, the system further includes an editor to receive a selection of a location in a video content from a user.

In one embodiment, the system further includes a pixel tracker to track a collection of pixels near the selected location through subsequent frames of the video content.

In one embodiment, the pixel tracker checks the presence of the pixel collection in a plurality of keyframes.

In one embodiment, the system further includes an object tracker to track an object near the selected location through subsequent frames of the video content.

In one embodiment, the object tracker tracks the object through the next four seconds of video content.

### BRIEF DESCRIPTION OF THE DRAWINGS

Exemplary embodiments of the present disclosure will be understood from the following detailed description when read with the accompanying Figures. In the drawings, like reference numerals refer to like parts throughout the various views of the non-limiting and non-exhaustive embodiments of the present invention, and wherein:

FIG. 1 shows one embodiment of a server platform providing video annotations in accord with the present invention;

FIG. 2 shows a mobile computing device playing a streamed video;

FIGS. 3-18c show an example of a user annotating a video and interacting with an annotated video in accord with the present invention;

FIG. 19 presents a method of displaying a video and the associated tags;

FIG. 20 illustrates how the system operates when it cannot successfully track a region of pixels representative of an object for a predetermined time;

FIG. 21 identifies the steps in the pixel region tracking process;

FIG. 22 shows one exemplary application of the pixel region tracking process;

FIG. 23 is a flowchart describing the attachment of a tag to a specific position in a video;

FIG. 24 presents the method for a user interacting with a tagged video;

### DETAILED DESCRIPTION

The present invention relates to a method, process and system for contextually augmenting and annotating moving pictures or images with tags using pixel region tracking on computing devices with screen displays, including mobile devices and virtual reality headsets. Embodiments of the present invention enable both content authors and viewers to directly tag and link supplementary content to a region corresponding to an object in a moving picture or an image and share these tags with other users.

The present invention relates to a platform which allows users to annotate a moving picture or image. Users can tag any region they identify in the video. Region tracking is used to detect and track the region that the user decided to annotate or tag for a predetermined time. Users can add content such as videos, comments, messages and other embedded content and or information to these tags. As a result, the platform offers a superior level of interaction and a more immersive consumption experience than traditional movies without this form of annotations.

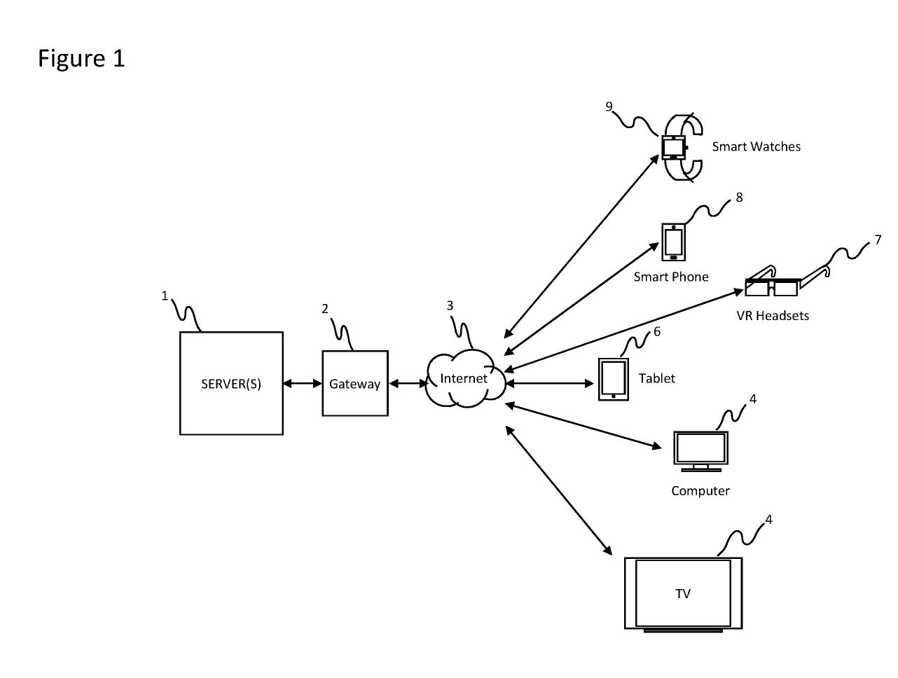

One embodiment of the present invention consists of a server platform as shown in FIG. 1. The platform includes at least one software client, which can also be an app, web app, website, plug-in, etc., (or any code that establishes direct communications with the services running on at least a server) running on a computing device, connected to a screen display or VR Headset (5,6,7,8,9). The software client may or may not be a dedicated client. The computing device, whether fixed or mobile, communicates over a standard network connection (3) using standard connection methods to a gateway (2) with at least one server (1) on the backend as shown in FIG. 1. The system may exist in distributed forms, or in a cloud environment, and/or as a standalone version or versions. In one embodiment, certain components such as user tracking, business intelligence, object tracking, or the supplementary or primary content may reside on a separate server or servers at a different location or different locations.

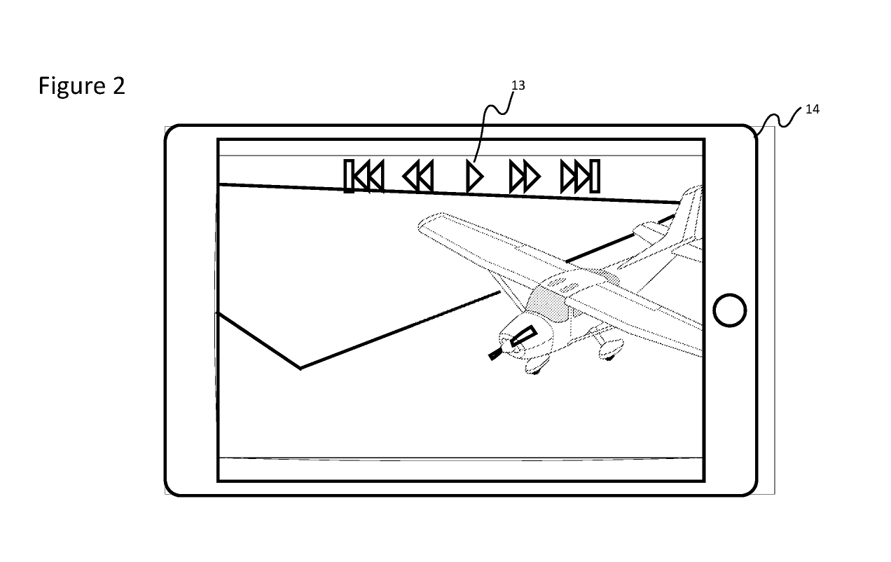

Video content can be played back and/or created using software on a computing device. In this example, FIG. 2 shows a mobile computing device (14) playing a video that is streamed from a server (1) to the device. The computing device (14) features standard controls known to video streaming applications (13). In one embodiment, there may be different clients or software applications with different types of controls with different functions that can be activated for specific users or user groups. In another embodiment, existing movie controls utilized by the playback software are used and additional controls and/or functions can be made available. In this embodiment all relevant data traffic associated with the tags, supplementary content and communications, is directed to the server (1) while the primary content, or other services may reside on a separate or existing server infrastructure.

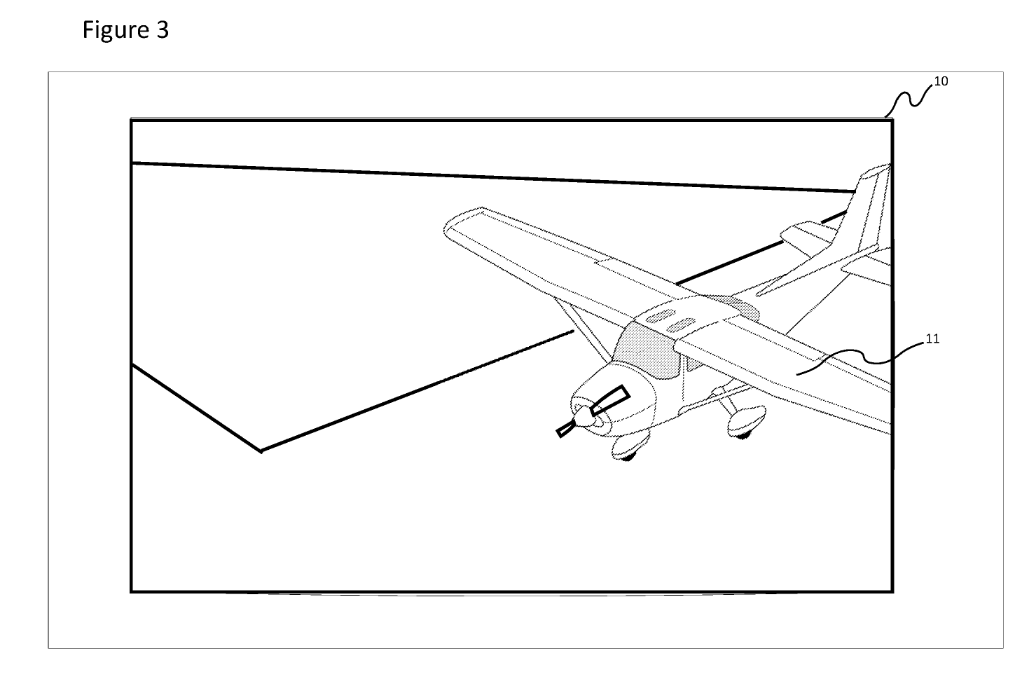

The following descriptions (FIG. 3 to FIG. 18c) explain in an example what a user experiences when creating and interacting with annotations or tags in embodiments of the present invention showing one method where identified regions are marked with dots and associated tags are placed on the bottom of the screen. In another embodiment, identified regions are directly marked with icons using the same region identification method described.

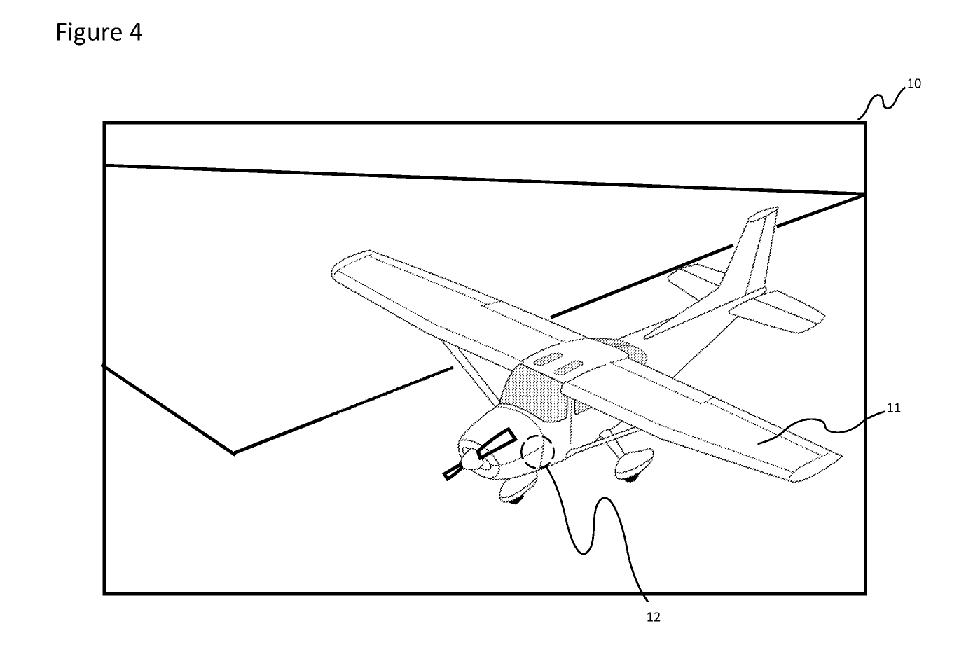

In FIG. 3 and FIG. 4, a video sequence plays which is streamed to a computing device (10) showing one object, in this example an airplane (11), which moves from the top right corner of the screen towards the center of the screen. The object and movement is for illustration purposes to show this method and process applied to create annotations, which we refer to in this invention also as Screen Tags. The video theme, objects, subjects, locations and their quantity, resolution and format may vary.

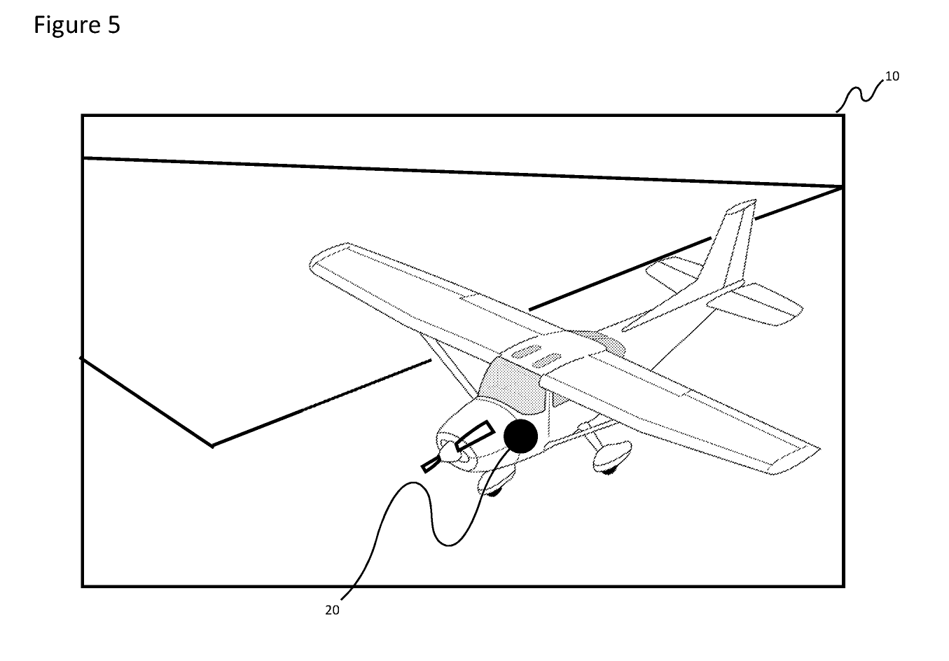

A user clicks on an object (11) at position (12) in a movie, where the object is the one to which the user wants to place or “attach” an annotation to. At the same time, or in another embodiment with a delay, the movie is paused or stopped. In this example, in FIG. 5, a user clicks on the side of the cowling of an airplane (20) to mark a location to place an annotation or Screen Tag. The Screen Tag serves as an anchor, placed by a user at a specific position (12) in a movie or image. This anchor or Screen Tag (20) is associated with the (x,y) coordinate of the position (12) and the frame number. In another embodiment, the Screen Tag (20) may also be associated with time.

Besides Screen Tags, which contain the annotation information, such as title, description, content, messages, URLs, as well as files of any type, there may also be Category Tags, to describe the category the annotation belongs to. In one embodiment, the Category Tags and the Screen Tags may also exist as a single tag with collapsible or variable windows, so that a user can access and interact with the information the user is interested in. In this example illustrated in FIGS. 3 to 18c there is one Screen Tag, which serves an anchor and a visual reference point rendered on the frames, a Category Tag, which is displayed on the bottom of the screen and a Descriptive Tag, which is an expanded view of the Category Tag. The Category Tag may be collapsible and/or expandable to minimize and maximize the view of the information. In another embodiment, not shown, the Screen Tag is an icon on screen depicting the type of content associated with that identified object. The Screen Tag can be clicked to reveal the associated type of content.

In this example as shown in FIG. 5, a user decides to attach an instruction video to the cowling in order to describe, for example, how to open the cowling to check the engine bay. The shape, color and form of the Screen Tag (20) may vary. Screen Tags (20) may be of different geometric shapes, colors or sizes, a logo, or text image, or any other graphical elements. Generally the idea is to make the Screen Tag large enough so that it is noticed, but at the same time not so large as to obscure the movie. For different screen types the system may use icons of different scale. In another embodiment the Screen Tags (20) may enlarge on mouse over.

Once the user identifies the object of interest where the Screen Tag should be placed, the system will attempt to identify the region using what is known pixel region tracking. Pixel region tracking is used to determine whether the collection of pixels in proximity to the location identified by the user can be tracked for a predetermined length of, for example, 4 seconds. The system will determine whether the pixels are trackable over this period so that a Screen Tag can be placed at the identified position as it moves for the predetermined length of, for example, 4 seconds, after which the Screen Tag will vanish even if the object is still visible or reappears afterwards. The 4 second interval, for example, gives a user enough time to recognize the Screen Tag or Category Tag and click on it to access the annotation.

During playback the system will display the Screen Tag for a duration of, for example, 4 seconds and the user may in this time have sufficient time to click and explore the Screen Tag. If the user decides not to click on the Screen Tag, the system will make the Screen Tag invisible. In one embodiment the time of, for example, 4 seconds may be variable and dependent on the number of screen tags visible. The system may display individual Screen Tags longer when more Tags are visible in a frame sequence.

Because it is not possible to attach annotations directly to a movie, one method is to create, for example, at least one invisible layer as shown in FIG. 25. This invisible layer matches the same number of frames and screen resolution as the underlying movie format and runs parallel with the movie. This invisible layer, which we call the Interactive Dynamic Content Layer (IDCL) (501), only contains the visible graphics, Category Tags and/or set of instructions and tells the system when and where a Screen Tag, annotations and information need to be placed. This Interactive Dynamic Content Layer (501) is the actual layer that pixel region tracking uses to detect the location of the user's clicking position (12) to create a Screen Tag. Because the Interactive Dynamic Content Layer does not contain the video images, the physical size of this layer is much smaller compared to the video layer (500).

In another embodiment, this layer (501) may not physically exist, as shown in FIG. 26. Instead only the screen information and position, such as frame number, time and/or (x,y) position, is being captured and separately stored in a database. The associated graphics are retrieved and matched to each corresponding video frame or image when it becomes visible on screen. The system will for each corresponding frame render the designated Screen Tag for the required duration and depending on user permission, certain users or user groups may view different sets of Screen Tags even though they view the same content.

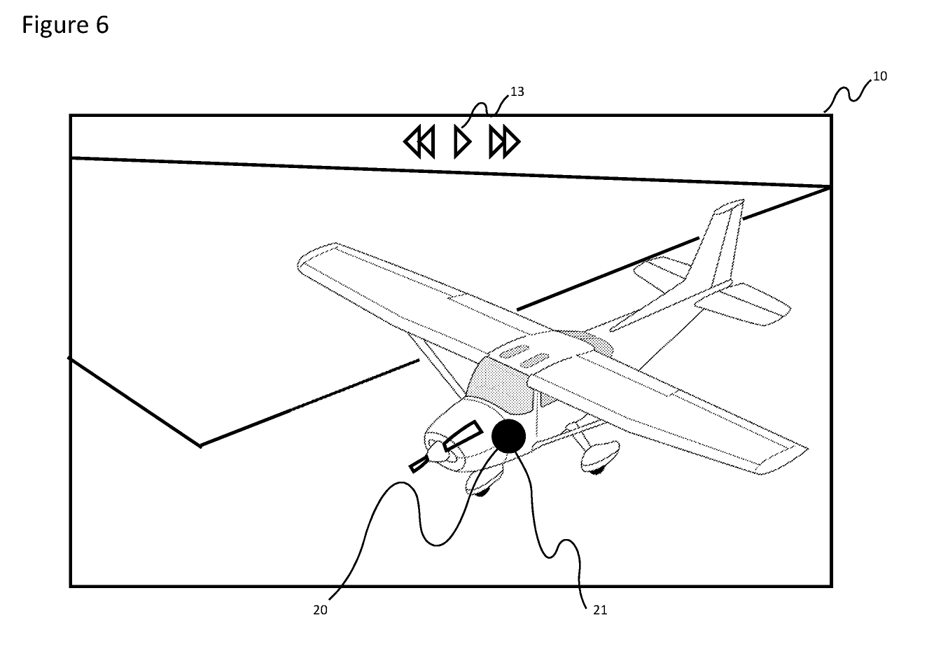

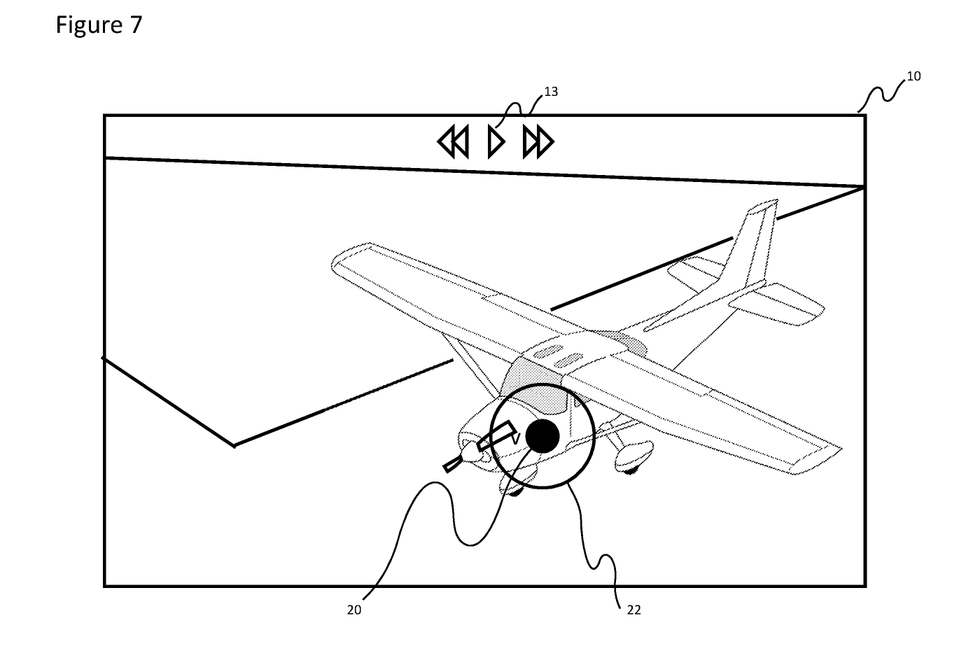

In one embodiment at least a play button, or other video control functions or buttons, are visible or are becoming visible (13) when a user clicks or interacts with the screen as shown in FIG. 6. The actual position of the movie control functions may be anywhere on screen. The video stops because it then allows a user to decide whether or not to delete or remove the Screen Tag (20) it created or open the screen tag. In case the user decides to delete the Screen Tag, the users can click the delete or remove button (22) of the Screen Tag as shown in FIG. 7. The position of the delete button is an example. It may also be at a different location or it might be a function in a menu. In addition, depending on authorizations the delete button may be inactive or hidden from view for specific users or user groups. In another embodiment, the users can invoke a cancel, delete or removal function by other means such as swiping across a screen with at least one finger or by other means. The idea is that a user has a method of removing his previous action of pointing at a location and inserting a Screen Tag, for whatever reason. In another embodiment the user can, by clicking on the video controls (13), continue playback in which case the system may show a message whether or not to remove the location of the Screen Tag (20) or not.

Once the user clicks on an object where the user wants to attach an annotation, the video stops or is paused and the pixel tracking process starts in order to determine whether or not the selected location is trackable or not.

The system may use one of several known methods for tracking the collection of pixels around the location where the user wants to insert the tag. These methods are, for example, a method by which video frames are compared to detect and track an object in motion. Another method is color comparison, where the system searches for color, shade differences. The system may decide not to use this method depending on light conditions and the quality of the video. Yet another method the system may use is markerless tracking, where the frame is converted to black and white to increase contrast. The slam-tracking method is another method that the system can use for tracking pixels corresponding to a selected portion of an object. This method uses reference points in high contrast images, which may be converted to black and white images, in order to detect and track an object. Besides these methods the system may use other methods for pixel region tracking.

Depending on the image, overall light conditions, image quality, object size and movement direction and other factors the system may determine by using a decision algorithm the optimum tracking method required to detect and track a group of pixels successfully for the duration of, for example, 4 seconds. In one embodiment the system will prioritize the methods by using the least amount of computing resources. In yet another embodiment, the decision for which method to use may actually change for every frame calculation. The system may use at least one method or use several methods and, or in sequence or any combination to determine whether or not a collection of pixels is trackable for a predetermined duration of, for example, 4 seconds.

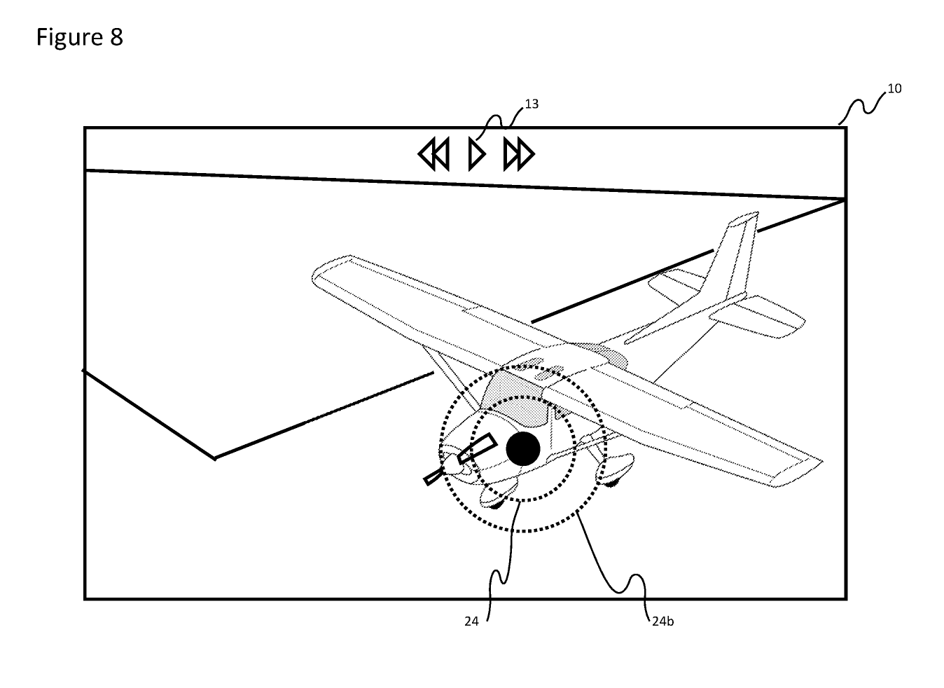

In one embodiment, as shown in FIG. 8, the system takes a predetermined area (24) of the image frame for the object tracking analysis to determine whether or not the pixels corresponding to the selected object at the clicked location is trackable for a predetermined duration of, for example, 4 seconds. By taking a specific area of a particular size instead of the entire image, the system will utilize a smaller area to successfully complete the calculations. This will help to optimize the overall object tracking calculation time.

As a first step, which might be optional, at least two key frames, which might be predetermined key frames, are initially used to determine whether or not the set of pixels is trackable before the calculations are extended to include the additional frames required to track the pixels corresponding to the object for the duration of, for example, 4 seconds. This first analysis step, will help to determine not only which of the methods to utilize but also whether the object corresponding to the selected location is at all detectable and trackable. Should the system determine that the object is not trackable it will then either abort further calculations or it will make adjustments in the selection, or apply different a method, etc. At this point, the user might be prompted to again pick the location for the tag and the process will start over.

In this example, as shown in FIG. 8, the predetermined area is circular, however the shape of the selected area (24) may vary. The size or shape of the area (24) may be determined by the area required for the system to perform a successful calculation for a specific number of frame calculations. The optimum size may over time yield a specific percentage of positive identifications and therefore the system will utilize this method over any other method.

In the present invention the pixel tracking analysis is only required for identifying a specific element the user clicked on and for tracking the pixels corresponding to the object for the duration of, for example, 4 seconds.

Normally object tracking methods continuously track whatever is in appearing in view or moving or centered on a camera. This is, for example, the case when tracking a car from helicopter. In these applications it is required to lock onto a specific object and to track it for as long as it is in view. However, in the present invention, object tracking is used differently. In the present invention, object tracking is used to detect and track a collection of pixels from a location selected by a user corresponding to an object for a predetermined time duration of, for example, 4 seconds, regardless of whether the object is afterwards still visible or not.

The idea is to use object tracking only for this brief duration so that the Screen Tag remains visible on the screen display long enough for a user to see it and to react with it. The time should not be too short, because a user cannot click on the Screen Tag if the tag disappears too quickly, and if it remains in view for too long it may obscure part of the video. The Screen Tag should be visible long enough for a user to notice it and to decide to whether or not to click and interact with it.

If the pixels have been successfully detected and tracked for, for example, 4 seconds then the tracking analysis is not required for this user selection after this 4 second interval, regardless of whether the object is still in view after that time period. However, if the pixels are not trackable within the predetermined time of, for example, 4 seconds the pixel tracking method may extend the time to include frames beyond the 4 second time. In addition the system may also take earlier frames for its calculation if the frames beyond the 4 second time interval do not yield a positive tracking result.

There are different ways how tracking calculations can be accomplished. One method is that the system starts out taking the first key frame where the user clicked on a location and then a second key frame within the 4 second interval, for example, to identify the clicked-on location. Or it might be several frames later or earlier, either predetermined or random. The system would start out by using the 1st frame and then it would then determine either the last frame of the required duration of, for example, around 4 seconds, or at least one, or several frame(s) earlier or later. It does not matter whether the exact time of 4 seconds is achieved, but it should be a period long enough for a user to see a Screen Tag and to interact with it when a video is running showing at least one Screen Tag.

In the case the video runs at a rate of, for example, 25 frames per second (fps), the last frame for the 4 second period would, for example, be frame number 100. Again this can also be approximate, it could be frame 101, frame 102 or even frame 99, which are all close to the 4 second mark and not noticeable to the user. The system would analyze the 2nd key frame to determine if the selected pixel region is detectable and trackable or not. Should the region not be detectable then it would, for example, check the frame at the 3rd second, or near the 3rd second, to determine whether or not the region is detectable or not at that time. The system can take additional, earlier samples until it finds a frame where the object is detectable.

When the region is not detectable and the tracking software determines that the region is, for example, not trackable after 3 seconds, the system will determine the number of frames between the last frame where the region is detectable and the predetermined period for display of the associated Screen Tag. Then it would attempt to supply the missing frames by analyzing frames prior to the user selecting the location. If the missing frames to fulfill the 4 seconds time requirement cannot be supplied by the earlier frames, then the system can check if the frames required for a 4 second interval can be found in frames appearing after the previously-calculated end frame. In this case, the system will check if the selected pixel region reappears and is visible for sufficient time to meet the 4 second interval. The system might, for example, only check the next 30 seconds of frames to determine if the frames contain the identified pixels. Then the system might present the findings to the user to find out if the user accepts this new location closest to the user's initial location for a Screen Tag.

In another embodiment, the system can check the frames in sequence. It will start with the frame that the user clicked on. In another embodiment the calculation can also start at the 100th frame and calculate backward. In another embodiment the system will check the key frames in sequence. For example the system would take the key frames 1, 20, 40, 60, 80 and 100 (25 fps for 4 seconds) for analysis to determine whether the selected pixels, whether in motion or static, are detectable and trackable. Or the system could take, for example, a random sequence 1, 19, 42, 59, 80, and 98 where the key frames are unevenly spaced out. Or, in another embodiment the system will take a random selection of these numbers. In yet another embodiment the system will start from either end using frame 1 and 98, for example, followed by 19 and 80, and so forth. The idea is to analyze only the key frames that are more or less evenly spaced out to determine whether or not the selection is trackable or detectable. If the selection is trackable, using these key frames within the required time of, for example, 4 seconds, then the selection is likely trackable in all the remaining frames in that interval of, for example, 4 seconds. If the detection and tracking of the selection is positive, the system will create a Screen Tag at the location of the identified location and track it for the duration of, for example, 4 seconds. In another embodiment, the system may determine, using an algorithm, to create a Screen Tag at the identified location and track it for the duration of, for example, 4 seconds when a specified minimum number or percentage of frames contain a valid selection.

After this predetermined time, of for example 4 seconds, the Screen Tag (20) disappears from view even though the selected region (12) may still be in view (FIGS. 4 and 5). The idea is to minimize the time a Screen Tag is visible on screen so that it does not obscure and interfere with the viewing experience. In another embodiment the system may at specific intervals, when the selected region reappears, redisplay the Screen Tag.

In order to shorten the overall calculation process and make it more efficient, the system can in one embodiment, as previously mentioned, use a predetermined frame selection (24) and use this for the region tracking analysis rather than taking the entire frame selection as shown in FIG. 8. If the system is either unable to identify the region using the predetermined area (24), or the system is unable to positively track the identified selection for the remaining predetermined duration of time, for example, 4 seconds, the system may increase the size of the area to be analyzed (24b) by a specific amount and then repeat the calculations to determine whether or not the selection can be tracked in the remaining frames for the predetermined duration of, for example, 4 seconds (FIG. 8). These steps may be repeated. The reason for starting the calculation with a smaller area (24) and then increasing the area (24b) in steps and repeating the calculation with a larger area is to reduce the required calculation time.

Generally, the tracking calculations are performed on the server but in one embodiment the tracking calculations may also be performed, in part or as a whole, on a software client.

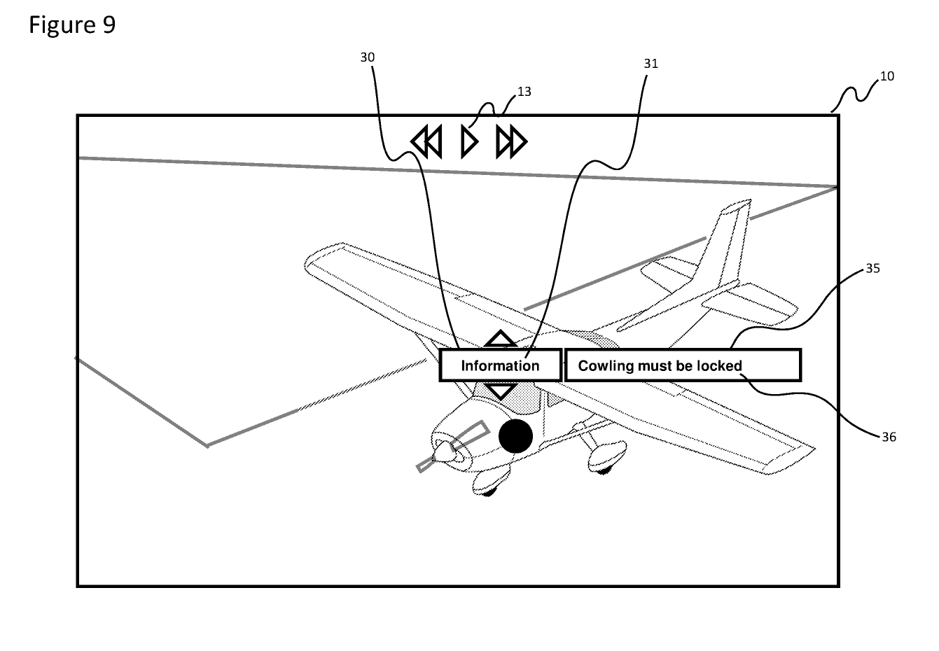

When the selection has been identified for the predetermined duration of, for example, 4 seconds, the system will display at least one Tag Window (30, 35), where a user can select from or type in information related to the Screen Tag that is being created as shown in FIG. 9. These can be separate windows belonging to a single or more Tags. In another embodiment, the user may select a type of icon that depicts the type of category that the annotation belongs to.

In the example shown in FIG. 9 the system will show a Tag Container (30) where the user can select a Tag Category (31), the position of which may vary. The Tag Category (30) may be predefined, either by the content author or the system administrator or it may be user defined. In one embodiment the container (30) and category (31) may be one unit.

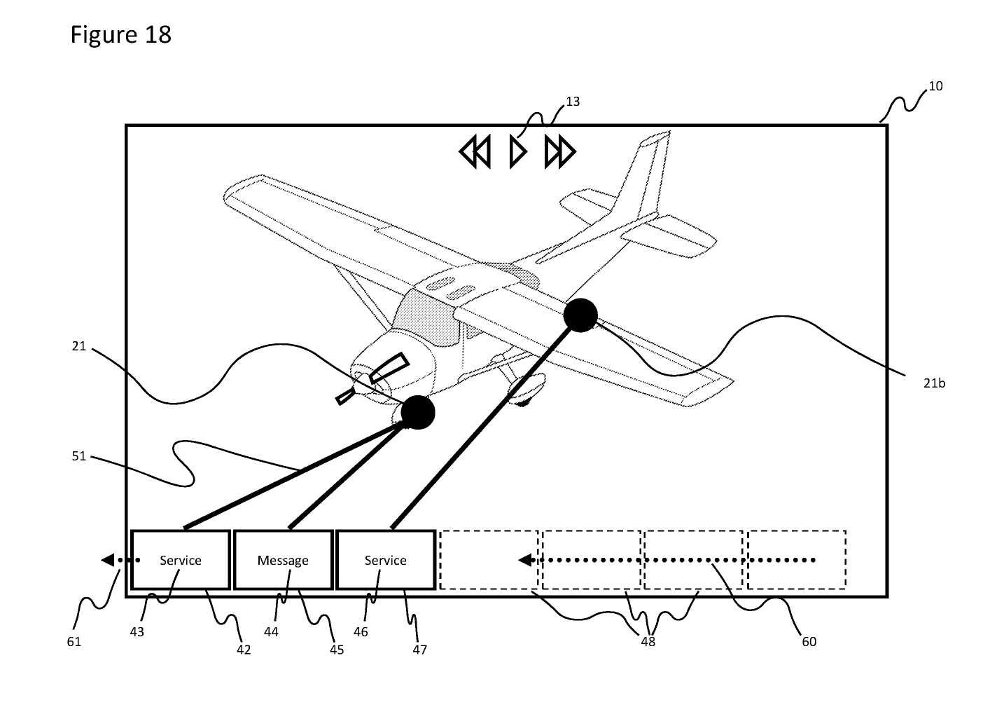

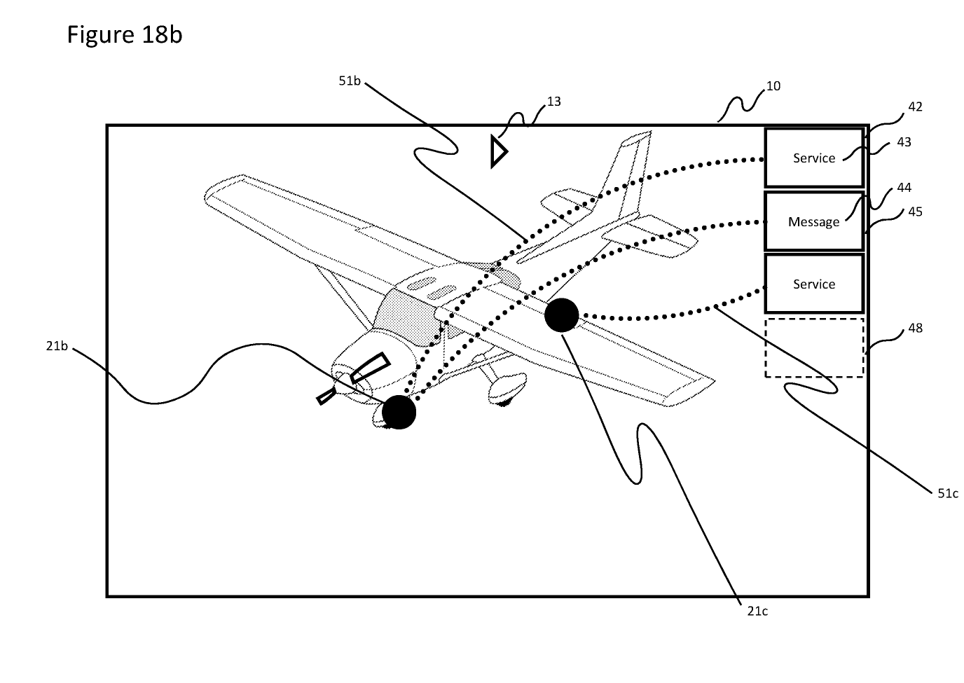

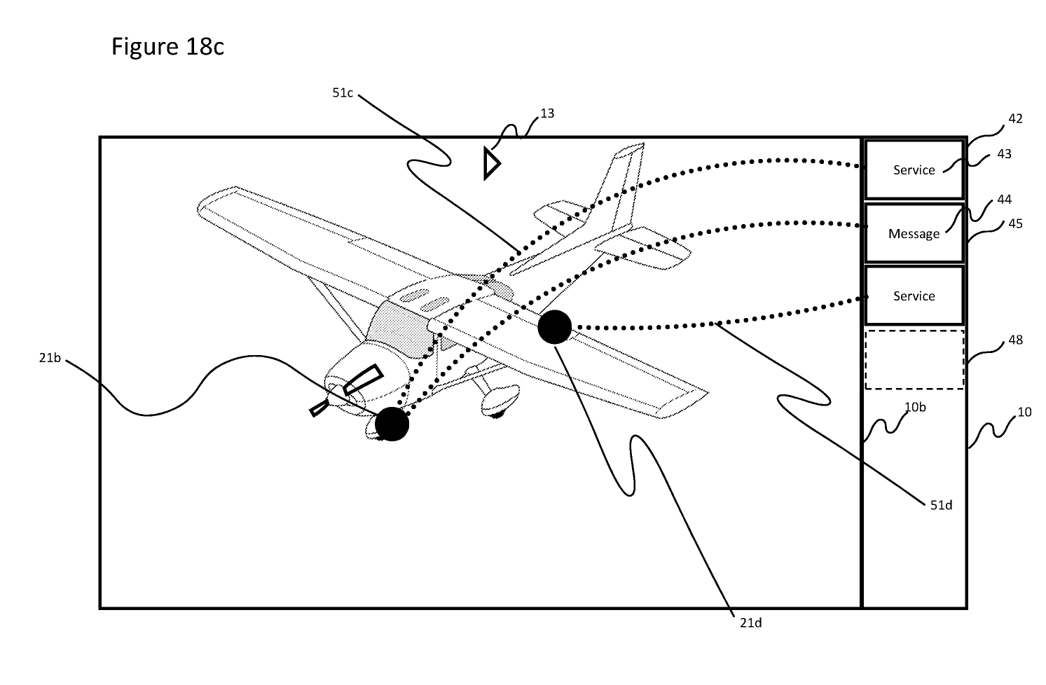

The idea is to offer a method of grouping Screen Tags shown on screen so that they can be displayed, filtered, searched or hidden by the viewer. A category will help to define the category that a Screen Tag belongs to. For example, there may be a Video Tag that then allows the user to upload or record a video which is then associated to that object that was previously identified by the object tracking for the period of 4 seconds. In addition all Tags used can be activated and made visible for specific users or user groups viewing the same video for example. In another embodiment users can be notified when new Screen Tags to a specific category appear. Similarly to emails, newly added Screen Tags can, for example, be separately listed and/or marked as new or unviewed. A user can, for example, click on a Screen Tag and it will then open the respective video and skip to the frame where the Screen Tag has been attached (FIGS. 18b and 18c).

In one embodiment, the Category Tags can have specific subject names, or for example, logos, icons, or other kinds of information, with different shapes or colors. In the present example the user selects from the dropdown the “information” topic in the Category Tag (31). Alternatively the title of the annotation can serve as a Category Tag. Users may in another embodiment decide which information is displayed for the Category Tag by selecting, for example, an icon or a name category from a dropdown or popup menu. The user can also enter a title in the Title of the Description Tag (35). Again both the Category and Description Tags may exist in one embodiment as one single tag with all required information. That single tag may be collapsible and display specific information when the video is played. When clicking on the tag the user can access the additional information associated with that tag. In another embodiment the Screen Tag, Category and Descriptive Tag may exist as one Tag.

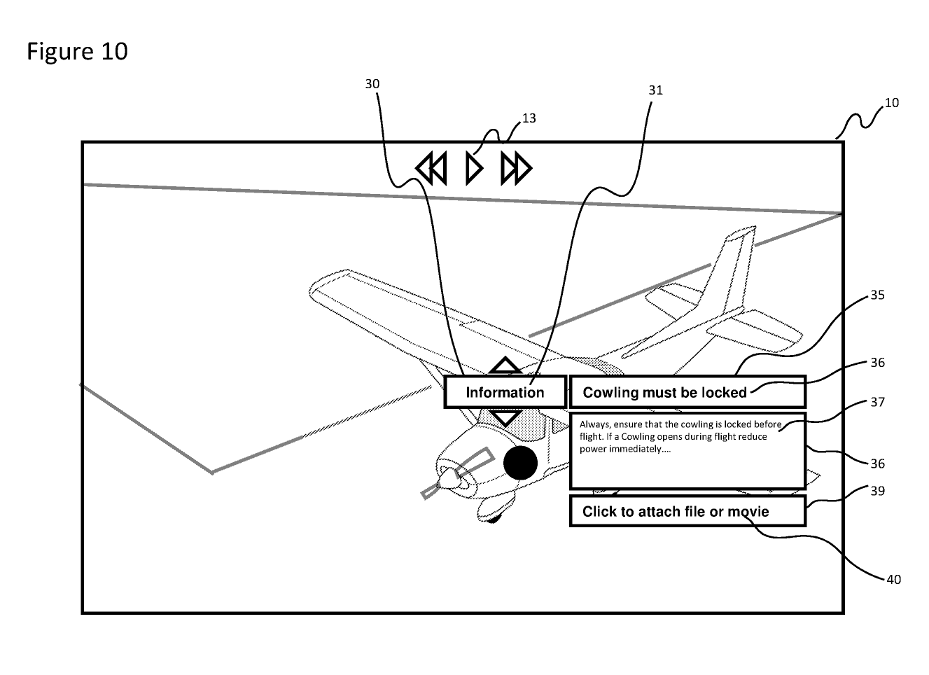

In another embodiment, as shown in FIG. 10, a user might add a description (37) or add, or link a file, or a video (40) or other data to the Description Tag, which in this embodiment consists of collapsible containers, windows or fields (35, 36, 39). The container for content (30) to describe the Description Tag may exist as a separate tag, such as a Container Tag, or be part of the Description Tag and be visible on demand by means of collapsing windows, containers for example.

When adding, for example, a file or video, the video is uploaded to the server and stored for streaming. In one embodiment the system may convert the file prior to upload to a specific format or formats in order to optimize the performance of this service. In another embodiment the content may be stored locally. Prior to uploading the video, image or other file may be checked for format type, size and other criteria to meet specific requirements before being uploaded. The file may also be converted and/or optimized, using file compression, codec conversion, file optimization or other means, prior to upload by methods known, or before being stored locally for access by the system.

The Tag Containers (30, 35, 36, 39) may be a single container with separate spaces to add the information, or individual containers, which may or may not be collapsible, as shown in this example in FIG. 10. The Tag Container or Containers may appear anywhere on screen. When authorized, users can add content in the Tag Containers, or the content can be removed or deleted. In one embodiment, a delete button may appear on the Screen Tag, or delete buttons also appear on/on top/next or near the individual containers (30,35,36,39,) (not shown), so that the user can delete the information or the Screen Tag, as shown in FIG. 10. In another embodiment the delete function may be part of a menu.

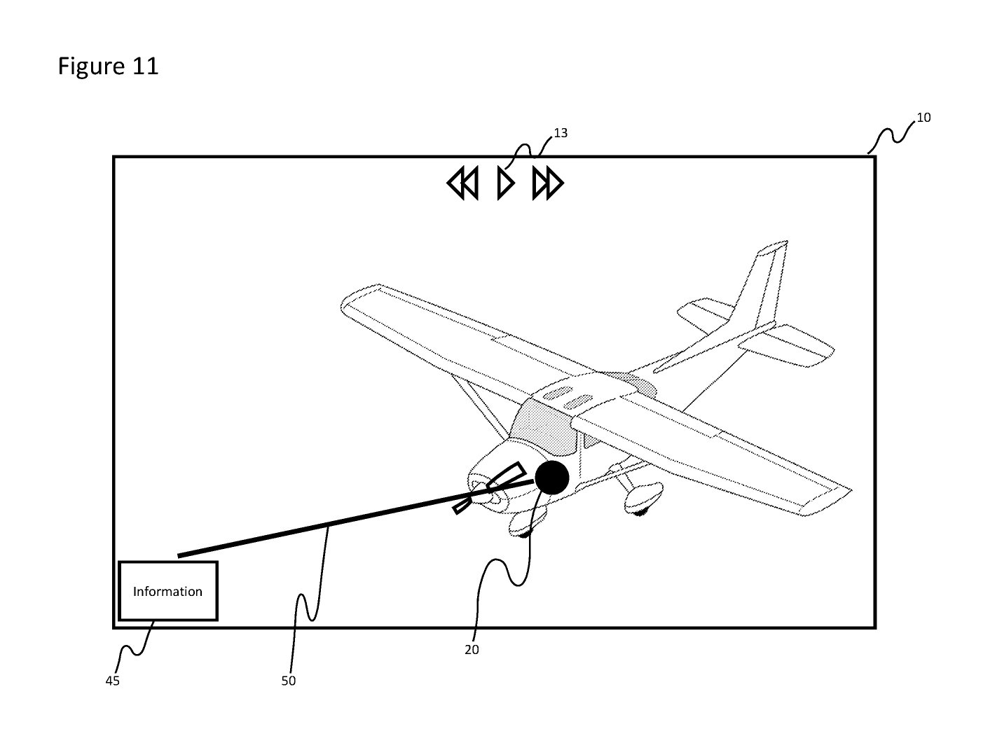

Once the information in the Tag(s) has been added, the system will in one embodiment display at least one Tag Container (45) visible at a specific location on screen as shown in FIG. 11. The category Tag container (45) is placed on the bottom of the screen so that it does not obscure the video viewing experience. The idea is to show a user that in a particular video sequence there are Screen Tags, which can be viewed when they are clicked on.

In another embodiment, the viewer may activate or deactivate the Screen Tags when viewing is required without Screen Tag information. In this example, the position of the Tag Container (45) FIG. 11, is at the bottom of the screen. The location and the size of the Tag Container may be different and may vary as shown in FIGS. 18b and 18c. The idea is to leave enough space to view the video. The Tag Container may display any information. This may be predetermined based on the settings. In this example the Tag Container shows the Tag Category labeled ‘Information’. The Tag Containers may in another embodiment be shown in a list view in a separate window.

In another embodiment, the system also displays a link (50) between the Tag Container (45). In this example, as shown in FIG. 11, the Category Tag, and the Screen Tag (20) are linked by a line (50), which may be of any size, shape, type or color. This link (50) will in one embodiment be visible for as long as either the Screen Tag (20) or the Tag Container (45) are visible. In the present example we assume this to be 4 seconds. If the Screen Tag disappears from view after the predetermined time of, for example, 4 seconds, then the link (50) will also disappear, leaving the Tag Container visible for another specified time.

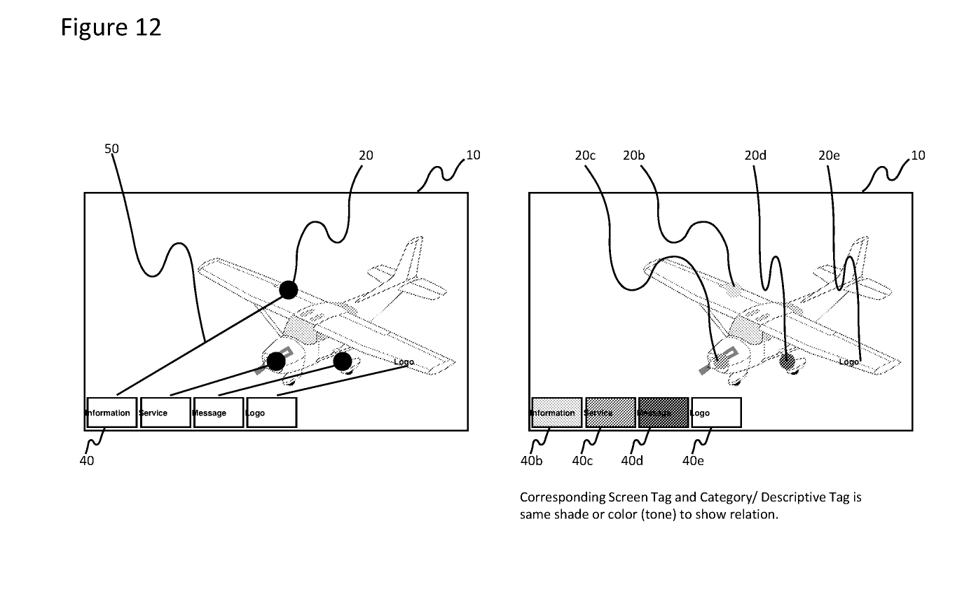

In another embodiment, the Link (50) can also be generated by giving both the Tag Container and the corresponding Screen Tag (20) the same color or shape as shown in FIG. 12. In yet another embodiment the corresponding Screen Tag and its Category Tag, or vice versa, may enlarge on mouseover revealing the selected corresponding tag. FIG. 12 shows that in a different embodiment corresponding Screen Tags (20, 20b, 20c, 20d, 20e) and Tag Containers (40, 40b, 40c, 40d, 40e) can each have matching colors, patterns, shapes, icons, logo or outlines instead of having a physical link (50) visually connecting the Tag Containers with the Screen Tags. In another embodiment, numbers, colors, icons, shapes or letters can be used to match the corresponding Tag Container and Screen Tag.

In one embodiment, as shown in FIG. 12, a physical link (50) is not necessary, which is preferable especially when multiple screen tags are visible at any time. The idea is to visually link the Screen Tag (20) with the Tag Container (45) on screen, so that users can identify which Tag Container (45) is linked to which screen Tag (20). As mentioned, this may be the case when there are multiple Tag Containers in view. During video playback, the Screen Tag (20) will follow the identified object (12) and if a Link (50) is used it will remain connected to the Tag Container (45) and the Screen Tag (20). After the predetermined time elapses the Screen Tag (20) and the link (50), if used, will disappear from view and the Tag Container (45) remains visible for further predetermined time. In one embodiment any Tag Container (40, 42), which may include the corresponding Screen Tags (20), are highlighted or marked otherwise when the corresponding Frame with the Screen Tag(s) (20) appear(s) in view. In one embodiment, the Tag Container (45) will also disappear from view concurrently with the Screen Tag (20). Once the Tag Container (45) has been created and a Link (50) is created, the video may either automatically continue playback, or the video resumes when the user presses, for example, a video control button (13).

In one embodiment it may be possible to have multiple Tag Containers (42, 45) linked to one Screen Tag (20) as shown in FIG. 18. In this embodiment it shows a single Screen Tag 21 with two links connecting to two different Category Tags. Note that this may also work without a link (51) by using similar shades, icons, or colors as described earlier. By using one Screen Tag for multiple Category Tags it reduces the requirement of having multiple Screen Tags on screen reducing clutter. In another embodiment Tag Containers may be linked or chained to more than one position in a video. This could either be the same cluster of pixels reappearing at a different frame location or another cluster of pixels that the user clicked on that was previously detected. This can be particularly helpful when certain information needs to be repeatedly mentioned in a video or other videos.

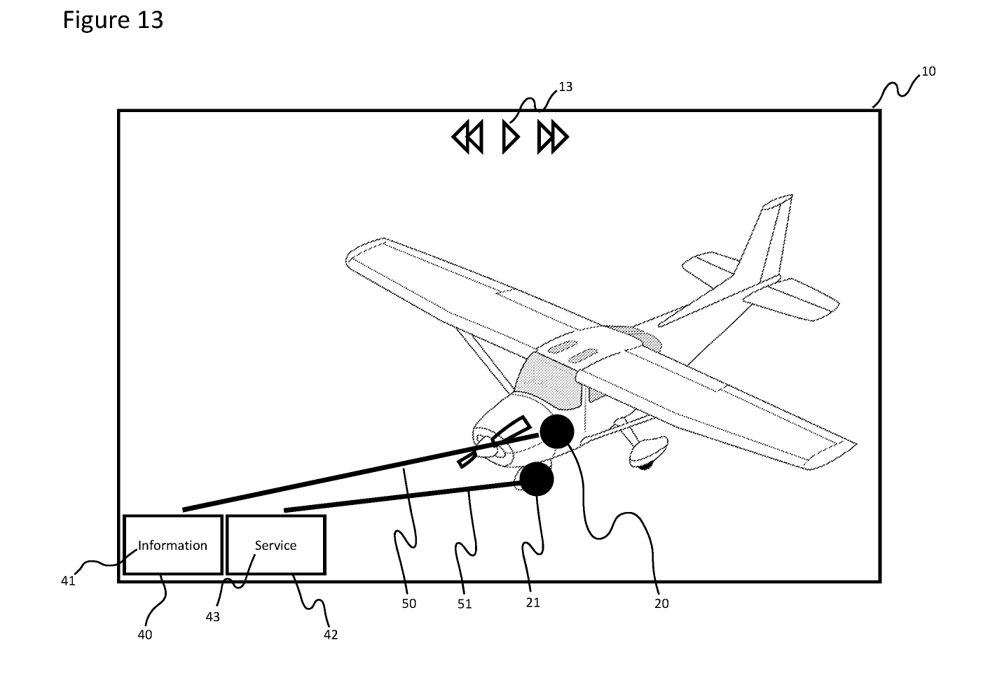

FIG. 13 shows a second Screen Tag (21) with a Link (51) to its corresponding Tag Container (42) pointing to a different element or part (21), which has been positively identified for a predetermined time of, for example, 4 seconds. The Tag Container (42), with another Category called Service (43) is shown next to the existing Tag Container (40) labeled Information (41). Any further Screen Tags appearing in view will position the corresponding Tag Containers in sequence, in this example, at the bottom of the screen display (10). The Tag Containers may also be positioned in other parts of the screen as mentioned earlier.

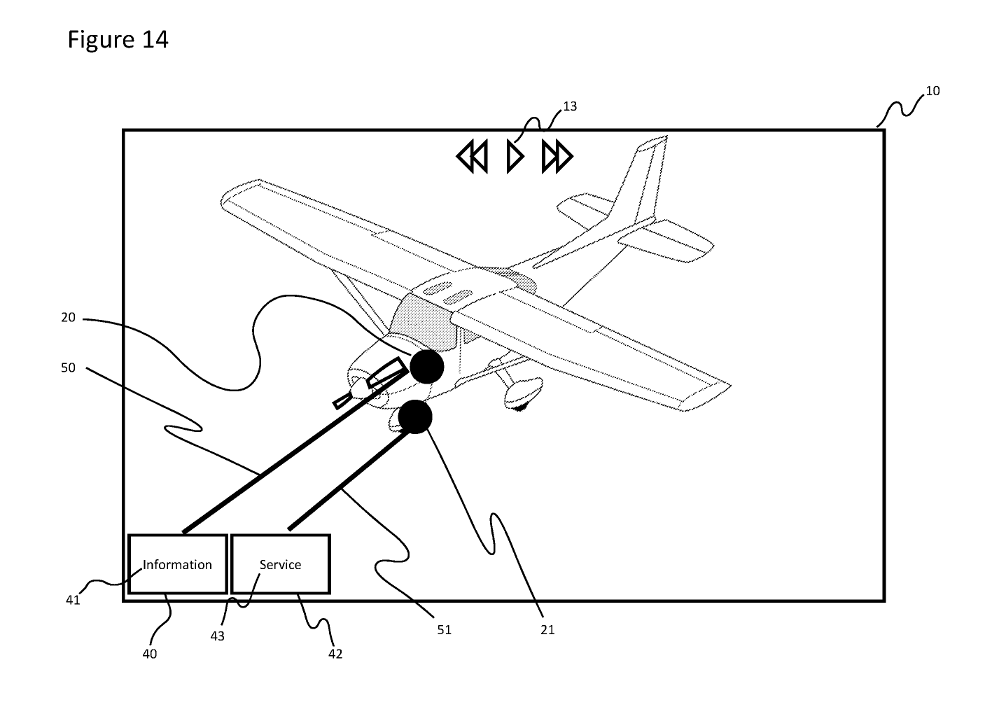

As the video plays back, the Tag Containers (42) will remain static while the Screen Tags will follow the positively identified parts and the Links (50, 51), if used, will remain connected with the Tag Containers (40,42) for a predetermined time of, for example, 4 seconds as shown in FIG. 14. In another embodiment where only Screen Tags are used, the clickable Screen Tags (20) will follow their positively identified elements for a predetermined time of, for example, 4 seconds and will then disappear unless a user decides to click on them, which will cause the video to pause to reveal the information of the tag.

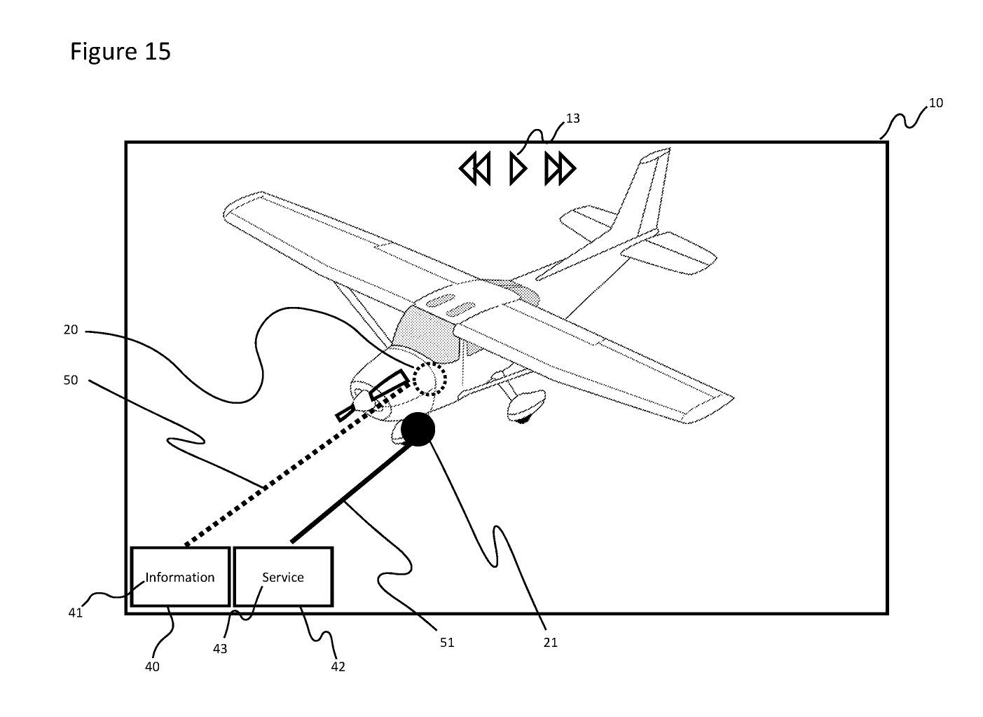

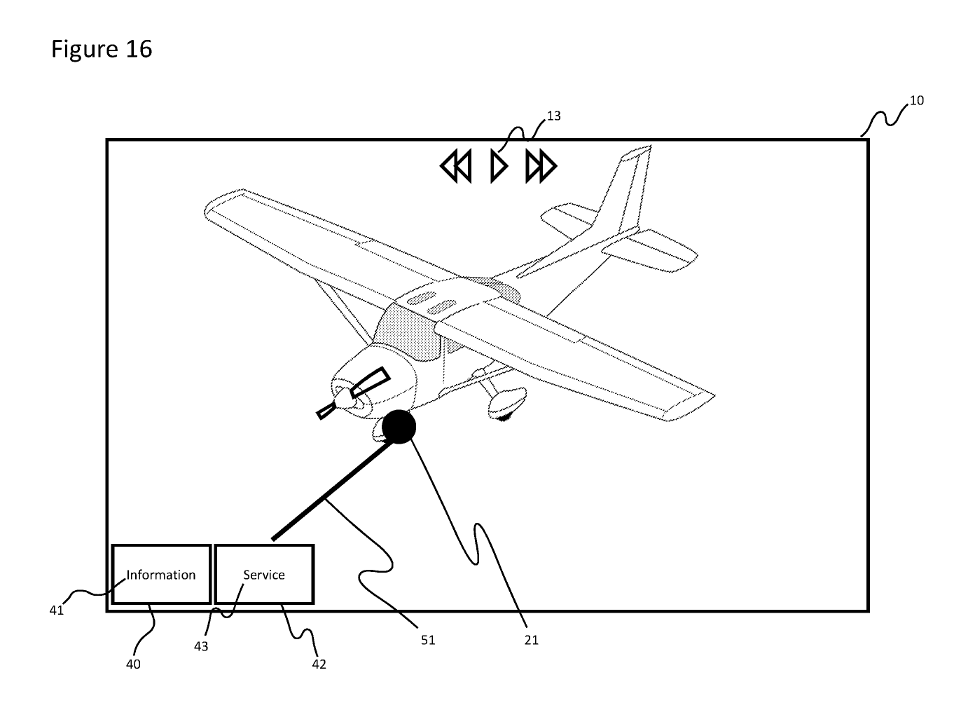

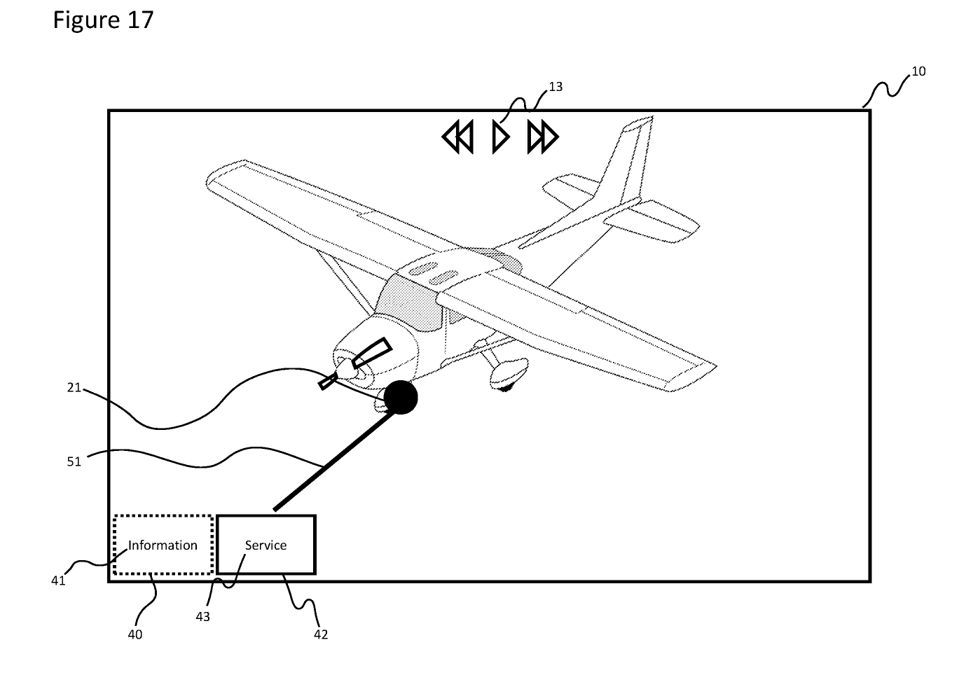

The Screen Tag (20) will remain in view for a predetermined time of, for example, 4 seconds, after which the Screen Tag (20) and the Link (50), if used, will disappear from view. In one embodiment, the corresponding Tag Container (40) will remain in view for a longer predefined period as shown in FIG. 15 and FIG. 16. After some predetermined time, the Tag Container (40) will also disappear as shown in FIG. 17. The following Tag Container (42) and all continuing Tag Containers (45) and (46) will shift over by one position, making room for more Tag Containers that will follow or appear.

In one embodiment, as shown in FIG. 18, the Tag Containers (42) and (45) have shifted to the left and a new Tag Container (47) appears in view with the Screen Tag (21b). The spaces (48) as shown on the bottom of the screen are reserved Tag Containers for any of the following Screen Tags appearing in the video. These spaces may or may not be visible and are shown to explain the method. In this embodiment the direction of new Screen Tags appearing would be from right to left, as shown by the arrow (60), which is an example to show direction. Alternatively, the direction could also be the opposite way or from top down or bottom up. Again the position of the Tag Containers are exemplary as are their sizes, shapes, logo, icons, and colors, which may actually vary. In one embodiment, the Category Tags on the bottom of the screen may actually appear longer than the Screen Tags, which are in view for, for example, 4 seconds. The Category Tags can stay for either a predetermined time of, for example, 15 seconds or they remain in view for as long as there is space. It would follow the first in last out method. FIG. 18b and FIG. 18 show the position of the Tag Containers on the right side of the screen (42, 45).

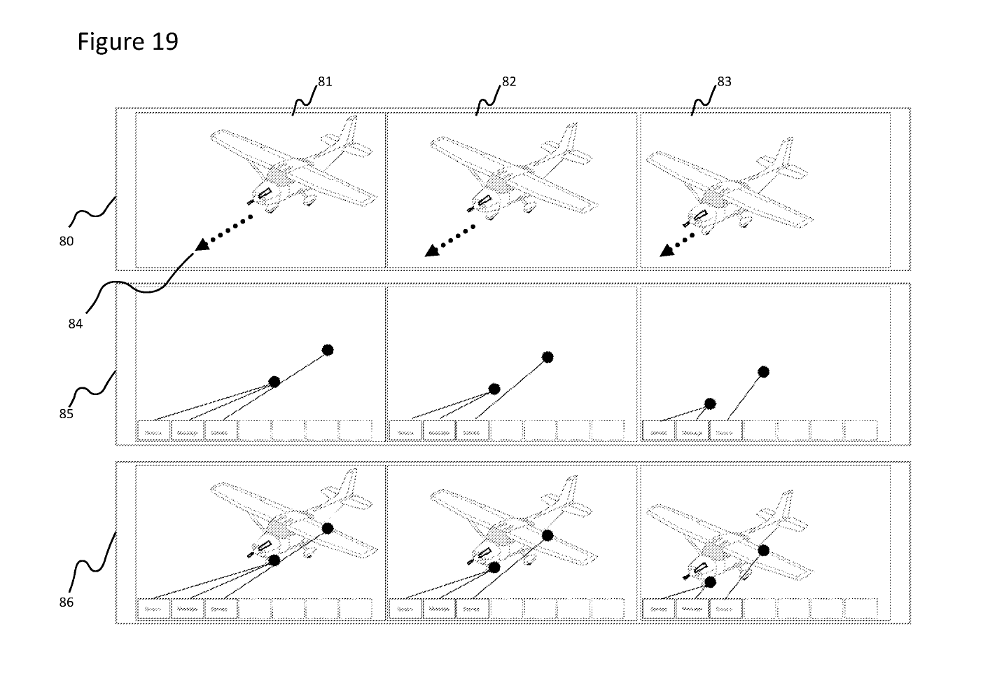

FIG. 19 shows a method of displaying the video and the associated tags that have been created. In this embodiment, the video and the graphical elements are separated, similar to a layer as described above in connection with FIG. 25. This embodiment (FIG. 19) illustrates as an example, a video (80) showing three frames (81,82 and 83) from a video sequence, where an airplane travels from to top right to the bottom left of the screen (84). Based on the videos frame count, time (optional), frame rate and screen resolution, or any combination of these, a separate interactive layer (85) is created that matches the exact same frame of the video. This interactive Dynamic Content layer (85), as described above in connection with FIG. 25, contains all the Tag Containers, Links and Screen Tags and their positions relative to the video (80). The video will show as an interactive video (86) with both the interactive Dynamic Content Layer (501) and the video layer (80) (500). For this it may be required to run a special software, plug-in, website, or player to display the video with the interactive graphics as an overlay layer. Without this the video will run on an existing basic video without presenting the interactive Dynamic Content layer (85) (501).

In yet another embodiment the system plays back the video and inserts at the required positions of each frame the Screen Tag graphics and associated information. The information and graphics is retrieved from at least one database as described earlier.

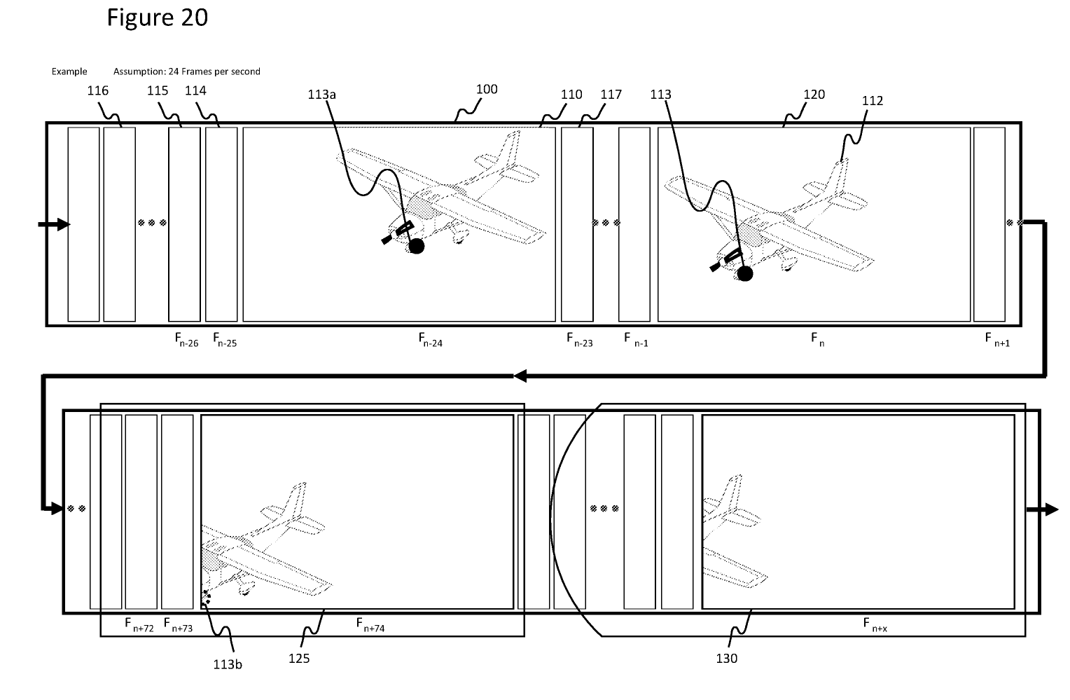

The next FIG. 20 illustrates more clearly how the system, or element tracking software, handles for example, a part (112) with an element (113) that it cannot successfully track for a predetermined duration of, for example, 4 seconds starting from Frame (120). This might be the case because the element at the desired location (113) the user identified, for example, cannot be tracked for the 4 seconds required for the system to create the Screen Tag (113) at the 4th second frame position (130). Alternatively, the part could, for example, become obscured by other elements for whatever reason. In this scenario, as described in FIG. 20, the region tracking software would calculate the missing number of frames to meet the 4 second requirement, for example and determine the last frame (125) where the Screen Tag was still visible (113b). From that point the region tracking software calculates backwards the required 4 seconds of frames required and determines that the frame (100) is the start frame required where the Screen Tag should be created to fulfill the 4 second requirement. If a positive tracking of the element can be maintained, the system would then insert the Screen Tag (113a) and create the Tag Container and the Link (50), if used, as described earlier. In another embodiment, the system would calculate the start Frame number by subtracting the still required missing frames from the frame Fn (120) to derive to the start frame (100). There may also be other methods to calculate the required frame number required.

Alternatively, in another embodiment, the system may also determine whether the element reappears after the predetermined time of, for example 4 seconds. The system may in such a scenario analyze further key frames within a predefined time, for example, 30 seconds, to determine whether or not this element reappears for the desired time of, for example, 4 seconds. If this is the case the system may inform the user that a new section has been found where the element appears, in which case the users can check if the detected sequence is suitable for a Screen Tag.

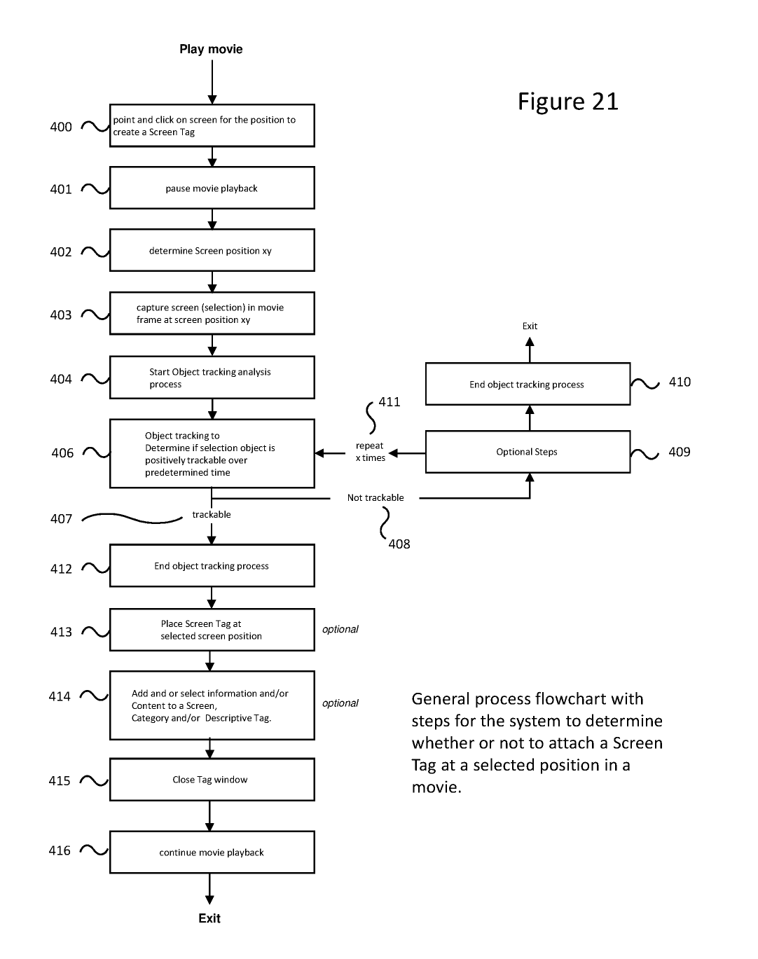

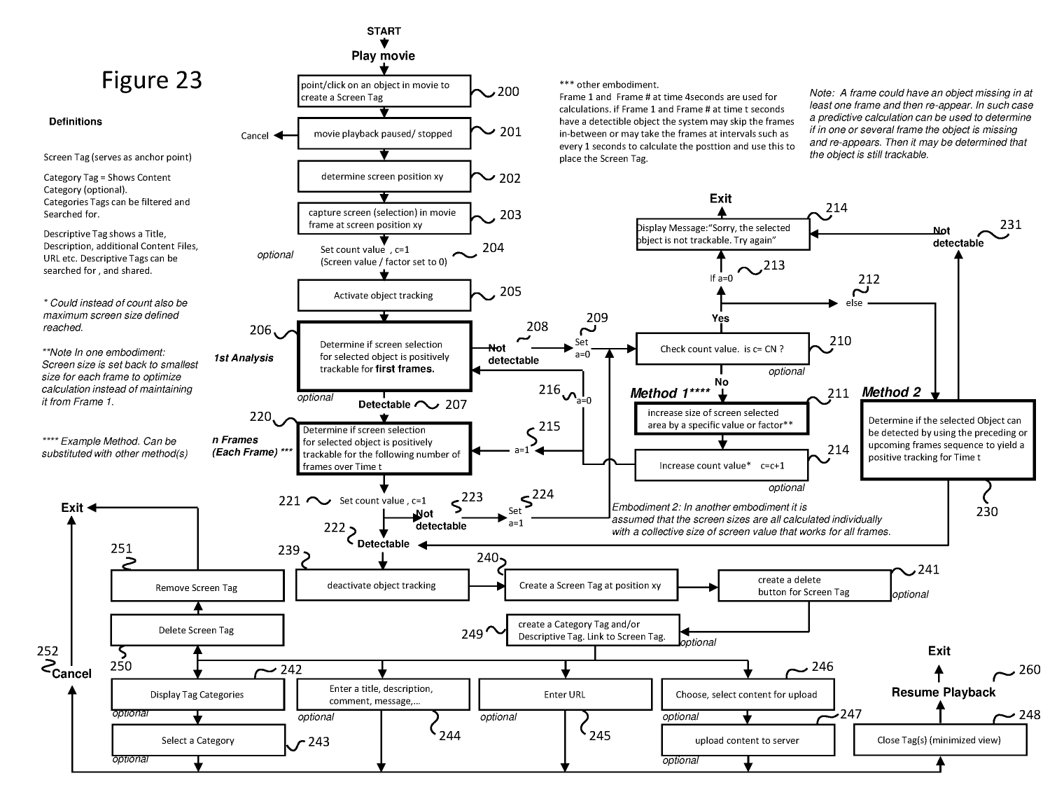

FIG. 21 outlines the steps for one embodiment of the element tracking process. The process described in FIG. 21 is an example and the process may slightly differ. FIG. 23 will describe this process later as an example with far greater detail.

Regarding FIG. 21 a video is playing in a software application (400) as described earlier. The user clicks on a location in the video generally corresponding to an object and consisting of a collection of pixels, which does not yet have a screen tag associated with that element. This action pauses or stops the video playback (401).

The software then analyzes the position by capturing the (x,y) coordinates of the location that the user clicked on (402). While in one embodiment, a specific screen selection is used for the calculation, in another embodiment the entire frame is used for element tracking analysis (403) as mentioned earlier.

At this point the element tracking software starts the process to determine whether it can track the selected part for the duration of, for example, 4 seconds (404). The element tracking calculation is only used from this point on for the duration of, for example, 4 seconds and it may in parallel process tracking requests for other parts. For this particular calculation the element tracking is activated (404) to calculate for this particular frame the part. Unlike traditional object tracking software like, for example, in security or military applications which require continuous analysis, in this invention the calculations for each element are limited to, for example, 4 seconds and additional frame calculations if the element was not trackable for that period. In one embodiment the analysis for this position is captured by taking the (x,y) coordinates of the screen position (20) of the frame (503) in the Interactive Dynamic Content Layer as shown in Exhibit 26. Again, the DCL may or not be a physical layer where this information is stored for each frame as described above in connection with FIG. 25.

The system will take different frames as mentioned before, within the predetermined time of, for example, 4 seconds (and may as mentioned deviate from this and pick frames beyond the 4 second time if the object is not trackable) in order to determine whether the object is trackable over the predetermined period of, for example, 4 seconds. This step may be preceded as described earlier by an optional first analysis, to determine whether or not an object can be positively identified and tracked.

Assuming that the element has been identified and is trackable (407) using the methods described earlier the tracking process is completed (412) for that particular part, the system will then place a Screen Tag (413) for the duration of 4 seconds. This might as described earlier be either at the position the user clicked on for the duration of 4 seconds or approximately for 4 seconds. Or it might suggest to place a marker at a different frame, as described earlier, because the element could not be identified for whatever reason.

Should the element tracking not be able to identify or track the part (408), the system will choose a different method or adjust the method accordingly for each calculation (409). Should the calculations exceed a specific threshold (411) the system may end the element tracking process (410) and inform the user that the selected part cannot be identified and/or tracked.

Once the Screen Tag has been placed at the location (413) and the user filled out the Description, added files or other information, and/or selected or added the Category Tag information the window can be closed (414). In addition the entries made and the marker can be deleted at any time. Once the window has been closed (415) the video continues playback (416) automatically, or the user may prompt the video to playback by clicking on the video controls (FIG. 23).

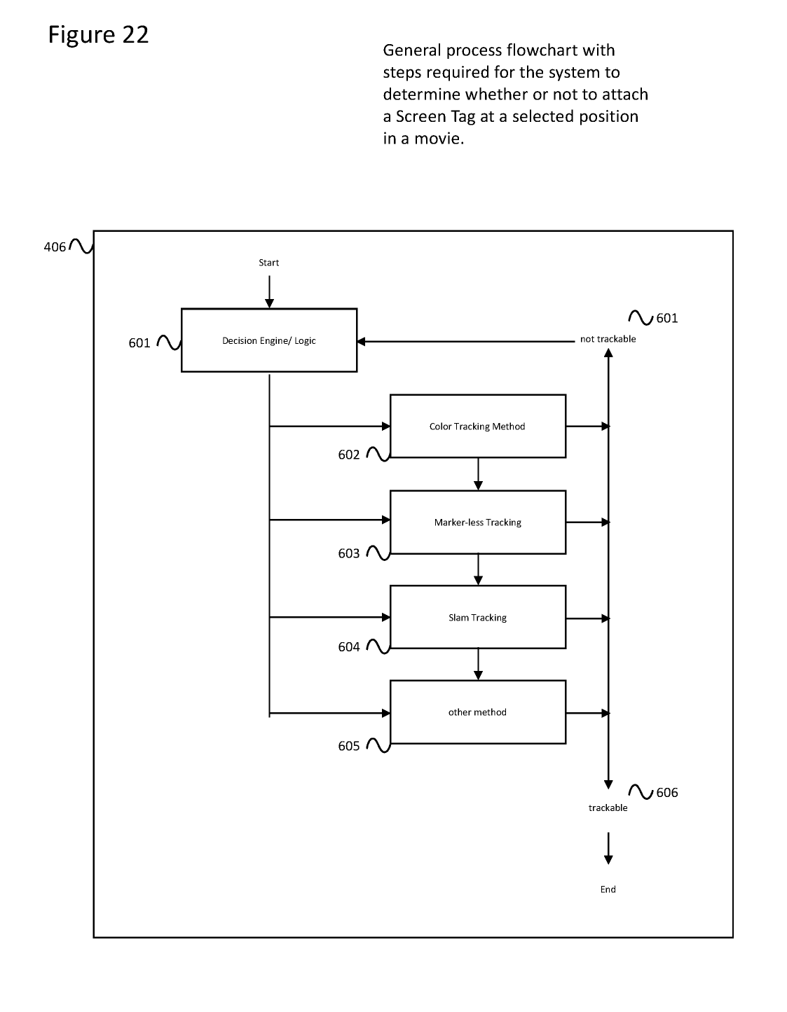

FIG. 22 shows a diagram showing the process that the element tracking may follow (406) by applying at least one method to determine whether or not a part is trackable (606) for a predetermined time of, for example, 4 seconds. In this example an algorithm or decision logic (601) determines which of the methods the element tracking will use to track the selected element. The element tracking may pick any method (602, 603, 604) or other methods (605) as shown in this example and repeat the method by making necessary adjustments to the actual method if the selected part is not trackable (601).

FIG. 23 describes in more detail using a flow chart the method or process of when and how a Screen Tag is placed at a selected position in a video. Placing a Screen Tag in a video frame requires certain steps. Many different Screen Tags can be created by different users and the number of Screen Tags visible in a particular frame is generally not limited. However, to reduce the number of Screen Tags, so that the video is not obscured, Screen Tags can be filtered or they can be shown based on, for example, the times when they were added. The methods for filtering or displaying Screen Tags may vary and can be set, for example, in user preferences.

To place or create a Screen Tag a user will play, for example, a video as shown in FIG. 23. The user would then point and click on an element in a video in order to create and associate a Screen Tag associated with that element (200). When the user clicks, or with slight delay, the video will pause or stop and be ready for playback when prompted by the user (201). At this point the screen position ((x,y) coordinates) of the clicked position is captured and then processed either locally or by the server in the backend (202). With the help of the screen position, the frame number, and (x,y) coordinates, which may or may not include the time information, the element is captured in the video using a predetermined selection size (203). In this example it might be a circle of 30 pixels diameter, the measurement may be also of a different measurement unit. However, it could also be a different area defined by a certain shape and size as mentioned earlier. This example in FIG. 23 assumes that a method is used that compares a screen selection of the video frame at the location that the user clicked on with the images of specific key frames.

When the selected area at the selected location has been captured in the video using the (x,y) coordinates, there is an optional step where a few values are set. The variables have no effect on the overall outcome. They are simply one of many methods for counting the times a set of instructions have been run and to determine which were the previous instruction set the software processed previously. In this example, the count value is set to 1. With this the number of attempts are counted that the software ran Method 1 and/or 2. For both methods there can also be separate counts. In addition, the Screen Value is set to zero at the start. This ensures that the last value of any prior calculation is not used for the current calculation. Hence that number is set to zero to ensure that the Screen selection size of Method 1 starts with the lowest, smallest predetermined selection area (204). In case the method is applied where the entire screen is analyzed the screen value may be omitted. In one embodiment, Method 1 (211) and Method 2 (230) can be substituted by any other method.

Next the pixel cluster tracking software is started for this analysis (205). The software analyzes the selected pixels captured from the video, in this case with radius 30 pixels, for example, and then determines whether it can or cannot detect the selected element. As mentioned earlier the software may do a first analysis (206) to determine which method to apply and to check if the object is element by using the first frame (206) and a second frame as preciously described. There might be, for example certain light conditions or other parts interfering with the element that needs to be detected making it impossible to positively identify the element, in which case the method needs to be adjusted or a different method needs to be applied. This first step analysis is not essential for the overall process or method. It is just one step in the process that helps to ensure that the pixel cluster tracking software can positively detect the element in the first frame.

If the element is not detectable in this first analysis (206), a variable, let's call it ‘a’, is set to the value ‘0’ (208). This is optional and not a requirement. The variable ‘a’, and it could be a different variable, only helps to identify where the workflow originated from. Depending on the programming language used this could be also achieved with different if/then/or else instructions or similar methods. In this case it was the first analysis, which had a negative outcome. Next the variable c is checked to see how many times the Method 1 was applied (209) so far. The variables can differ and are only an example. If the value c=CN, where CN is, for example, number ‘5’, it instructs the software basically not to further increase the screen selection size, and/or conduct another image analysis using a different method and pick a larger predefined area. This might be, for example, because the element cannot be tracked due to different reasons, such as, interference or the element being obscured by other parts, bad light conditions, etc.

Or there might be a situation where the element suddenly disappears within the predetermined time frame. If the number of screen selection increased is below ‘5’ attempts for example, or a specific predetermined maximum selection size has been reached, the Method 1 (211) is applied and the selection size is increased by a specific size or increment each time. In this case the radius is increased from 30 to 60 pixels, for example. The Screen selection is again captured in the video frame (not shown in this flowchart) and the count is increased from 1 to 2 attempts (214). Because the value ‘a’ was set to 0 (209), the process flows via (216) back to (206) where the element tracking software again determines whether it can positively identify the required frames to make the element trackable for the predetermined time of, for example, 4 seconds.

As previously mentioned the system may pick any number of frames with different times apart to calculate whether or not it can positively track the element. In case the software cannot detect the element in at least one frame (206), the region tracking software would again apply the first method (211) until value c or a specific maximum limit for the screen selection size has been reached (210).

If the maximum attempts have been reached for the First Frame analysis (210)(213) then the software would display a message to the user that the software is unable to identify the element in the first frame (214). If the element is not trackable in the following frame calculation (208), then the element tracking software would attempt, after reaching the maximum allowable screen selection size or factor (210), to proceed via (212) to Method 2 (230). Method 2 (230) would be applied when Method 1 has failed to detect the element. It would, for example, also be possible that the element could have disappeared from screen, with the option of reappearing at a later stage. In another embodiment the element tracking software could suggest that it found the element at a later Frame n and it could in addition make this suggestion as this would then meet the 4 second object tracking requirement. In another embodiment, the screen selection size value after the calculations have been completed and the element is detectable (222) or not detectable (214) would be set to the zero value (not shown).

As described earlier, in Method 2 (231) the element tracking software determines at which frame number the element is not visible or trackable anymore. It would then determine whether the element might be trackable in the preceding frames, before the frame that the user clicked on the element. If, for example, after 3 seconds the element cannot be identified, the system would try to determine whether the missing 1 second can be taken from the preceding frames. In that case the Screen Tag would be placed 1 second earlier than the frame that the user actually clicked on to pick an element.

Alternatively, in another embodiment the system might check the following frames beyond the 4 second mark if it is unable to detect the element. This could be restricted to a certain time value, for example, 30 seconds in order to prevent the system from spending too much time detecting a four second interval closest to the location that the user clicked on. In addition, the further the location is away from the point that the user originally chose to be annotated the less likely that element might be an alternative because the scene is for example different.

The user may be prompted to agree if the system selects the earlier position in which case the video might be skipped to that position. If this method (230) is not successful and the element cannot be positively tracked (231) a message would appear stating that the element cannot be tracked (214). If the tracking software can positively detect the element (222), the element tracking is deactivated for this tracking calculation (239) and the system would render a Screen Tag at the selected position (240). In one embodiment a delete button might be placed so that a user can delete the Screen Tag, so that the Screen Tag can be deleted (241). This might be optional and or occur concurrently with step (240).

Once the Screen Tag (240) is placed the user can select to create or choose a title or icon for a Category Tag to define the category for the information what is being added to the Screen Tag (249). In one embodiment a separate Tag is created. This Descriptive Tag (249) contains all the information including the category, for which in another embodiment there might be a separate Tag, called Category Tag. The idea is that in one embodiment the Category Tag is visible on screen and that the descriptive information of the content is available when a user opens the Category Tag for example.

The user can, for example, enter a Title, a description or comment, message (244), a URL (245) or any other data, files, or information to either the Screen Tag, or the Descriptive Tag or Category Tag. In one embodiment, the system may use the Tags to place advertising. In yet another embodiment the Screen Tag or Descriptive Tag may contain a chat or messaging services that allows users to leave live comments. In this case users can chat using audio, text or video within the Tags at a specific location in a video. The system could track the chat interactions and display in which frame the collaborations are taking place. By using what is known as heat maps it will show other users where collaborations are or have been taking place in a movie.

In one embodiment Screen Tags, Descriptive, and Content Tags may be activated and visible for specific user groups. This helps in educational environments where the same video is being used for different classes for example. One class will receive one set of Content Tags while the other receives a different set of Content Tags. This might also be used where Tags are used to place advertising messages. In this case Tags open automatically, if the video has paused in the frame containing tags. A user can then close this Tag containing the ad first.

It is also possible to select and add a video (246) or another file. This video might be of any type or format and might be preconditioned or converted to meet a specific format for optimized streaming performance (247), the methods of which are commonly known today. The user can at any time close the Tag (248) or cancel (252) the entries, or delete the Tag (250), in which case the Screen Tag and or Tags are removed. The video that is uploaded may also contain Screen Tags or a user can add screen tags to this video following the same process as described in this invention. When the video or content has been uploaded to the server (247) and the Tag(s) have been minimized or closed (248) the video playback may resume (260) either manually or automatically from the frame position where the Screen Tag has been placed at.

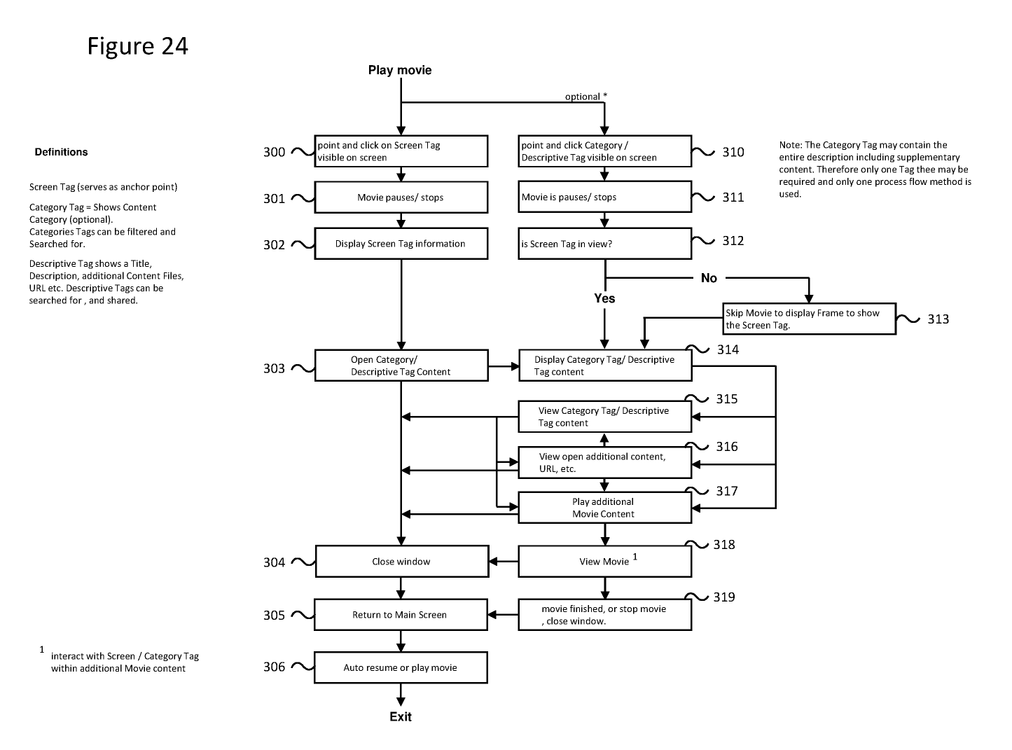

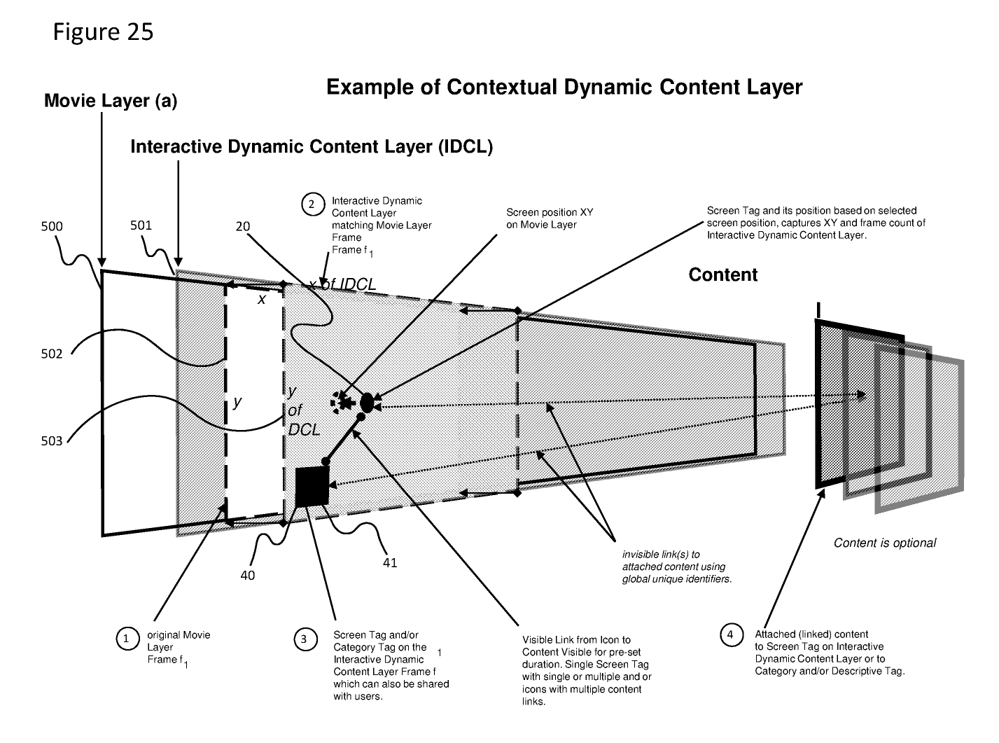

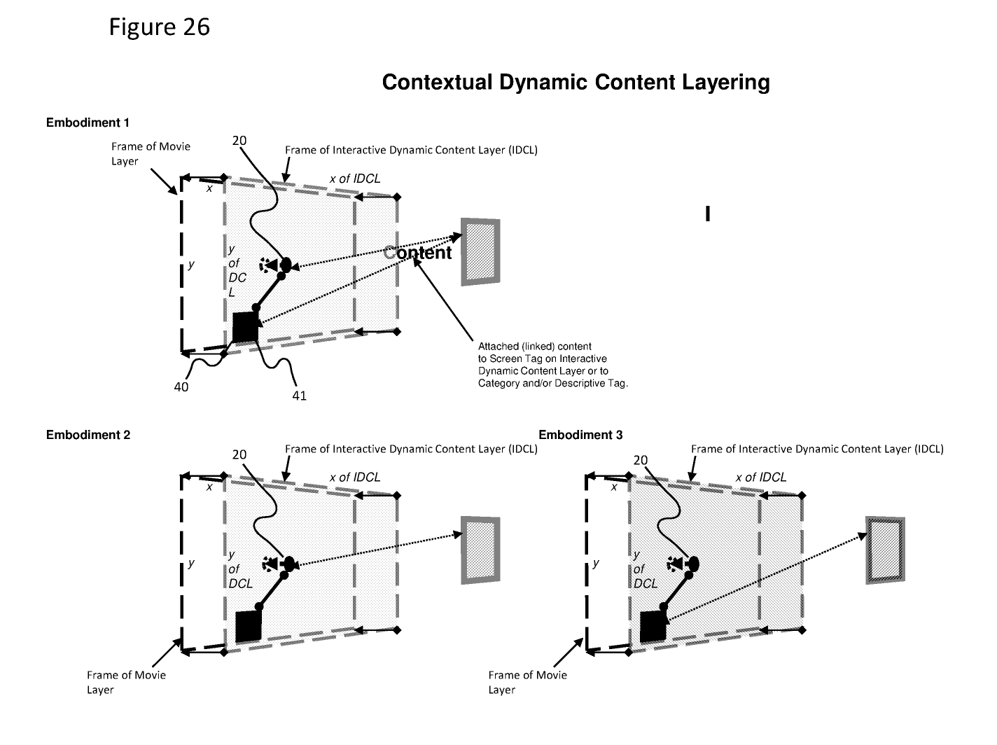

FIG. 24 describes the method by which a user would interact with a video containing Screen Tags. This process starts by playing a video that contains at least one Screen Tag that has been added as previously described in this invention. By clicking on a Screen Tag that appears during a video playback (300), the video would pause or stop playback (301). In another embodiment the movie may pause whenever a user hovers over a Screen Tag. In which case the Screen Tag could slightly enlarge showing the Screen Tag that the user hovered over. This would either show the relevant Screen Tag information immediately or in another embodiment require a second click, or with a delay, to show the Descriptive Tag ad or Category Tag (303). In one embodiment it would display and highlight, or with other visual cues, bring to the users attention the Screen Tag of the Descriptive or Category Tags (303) that the user selected on screen. This would be the case when the Screen Tag and the Category Tags are separately displayed. When several Category Tags or Descriptive Tags are shown for example on the bottom of the screen the user may click on any of them, which will then highlight the corresponding Screen Tag.

When the user finishes examining the content he can close the Tag Window (304). A user may be automatically redirected to the Video or this can occur manually (305). Then the user can continue video playback by clicking on the video controls or this process could also start automatically (306).

In one embodiment, a user can also click on the Descriptive Tag or Category Tag that are visible on screen (310). These remain visible for a longer time than the Screen Tag as mentioned before. When a user clicks on a Category or Screen Tag the video is paused and if the Screen Tag is not in view (312) the video is skipped to the position where the Screen Tag is visible (313, 314).

The user can then interact with the Tags (314) and explore the information, content (315, 316) and play a video for example (317). A linked video will appear and may also contain Screen, Descriptive or Category Tags with the relevant annotations and content (318). Please note that in this invention any kind of content can be displayed in Tags. This may for example include also advertising, which might use a different method for interacting as described here. When closing the window or Tag (304) the system returns to the screen of the main video where the user clicked on the Category, Descriptive or Screen Tag (305). Then the user can continue video playback by clicking on the video controls or this process could also start automatically (306).

The use of Screen Tags and Category Tags offers an inherent advantage over existing annotations. Tags may contain supplementary information that is far more detailed that would normally not be shown in a traditional video. Moreover, all users can use Tags to annotate videos and they can be shared with other users. Because of this far more data can be collected because users interact now with the videos and the tags. All interactions, annotations, tags are stored and provide valuable information for the content publisher and author as well as advertisers. By analyzing the data using business intelligence it is possible to determine the level of interaction on a frame basis. This helps to distinguish the most valuable sequences in a video. Moreover the value of a video can now be better compared to other videos because the level of user interactions and number of tags provide additional cues to whether or not to view a particular video. For advertisers this is helpful because ads can now be placed precisely at those locations where they are most relevant and where most interactions take place.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for annotating videos, the method comprising:
receiving a selection of a location in a starting video frame from a user;
identifying a first group of pixels in proximity to the selected location;
determining whether the first group of pixels can be tracked through subsequent video frames for a predetermined period of time; and
permitting the user to attach a tag to the selected location if the first group of pixels can be tracked for the predetermined period of time.

2. The method of claim 1 further comprising playing the video while displaying the tag attached to the first group of pixels beginning at the starting video frame and finishing after the predetermined period of time.

3. The method of claim 1 wherein the predetermined period of time is approximately four seconds.

4. The method of claim 2 further comprising associating content with the tag.

5. The method of claim 4 further comprising displaying the associated content upon interaction with the displayed tag.

6. The method of claim 2 further comprising disabling the display of the tag during subsequent plays of the video.

7. The method of claim 1 wherein the attached tag is stored in a transparent overlay separate from the video.

8. The method of claim 1 wherein information concerning the attached tag is stored in a database.

9. The method of claim 1 further comprising selecting a second, larger, group of pixels in proximity to the selected location when the first group of pixels cannot be tracked for the predetermined period of time.

10. The method of claim 9 further comprising determining whether the second group of pixels can be tracked through subsequent video frames for a predetermined period of time.

11. The method of claim 10 wherein the predetermined period of time is four seconds.

12. A system for annotating video, the system comprising:
a source of video content; and
a database of tags, each tag being associated with an element in a video content for a predetermined period of time.

13. The system of claim 12 further comprising a player to display video content from the source of video content and at least one tag from the database of tags in proximity to the element in the video with which it is associated.

14. The system of claim 13 wherein the player displays the at least one tag in a transparent layer overlaid on the displayed video content.

15. The system of claim 12 further comprising an editor to receive a selection of a location in a video content from a user.

16. The system of claim 15 further comprising a pixel tracker to track a collection of pixels near the selected location through subsequent frames of the video content.

17. The system of claim 16 wherein the pixel tracker checks the presence of the pixel collection in a plurality of keyframes.

18. The system of claim 15 further comprising an object tracker to track an object near the selected location through subsequent frames of the video content.

19. The system of claim 18 wherein the object tracker tracks the object through the next four seconds of video content.
